(19) United States
(12) Patent Application Publication
(10) Pub. No.: US 2025/0271412 A1
(43) Pub. Date: Aug. 28, 2025

(54) TWO-SIDED SCANNING APPARATUS FOR ANALYSIS OF AGRICULTURAL PRODUCTS

(71) Applicant: ZoomAgri Inc., Buenos Aires (AR)

(72) Inventors: Paula Silvina Digilio, Buenos Aires (AR); Alan Jonathan Elkin Minuchin, Buenos Aires (AR); Ariel Alejandro Hernandez Estevenz, Buenos Aires (AR); Fernando Miguel Martinez de Hoz, Buenos Aires (AR); Maximiliano Marufo de Silva, Buenos Aires (AR); Martin Perez Mendoza, Buenos Aires (AR); Rocio Alvarez Merce, Buenos Aires (AR); Matias Guillermo Micheloud, Buenos Aires (AR); Gustavo Daniel Ragay, Buenos Aires (AR); Jacob Willem Rommelaar, Buenos Aires (AR); Ramiro Verrastro, Buenos Aires (AR)

(21) Appl. No.: 19/205,537

(22) Filed: May 12, 2025

Related U.S. Application Data
(63) Continuation of application No. PCT/US23/80322, filed on Nov. 17, 2023.
(60) Provisional application No. 63/426,528, filed on Nov. 18, 2022.

(51) Int. Cl. G01N 33/02; G01N 21/84; G01N 21/88

(52) U.S. Cl. CPC G01N 33/025; G01N 21/8806; G01N 21/8851; G01N 2021/8466; G01N 2021/8841; G01N 2201/104

(57) ABSTRACT

This disclosure enables various technologies for enabling various analysis of various agricultural products.

### CROSS-REFERENCE TO RELATED PATENT APPLICATIONS

This patent application is a Continuation of International Patent Application PCT/US23/80322 filed 17 Nov. 2023; which claims a benefit of priority to U.S. Provisional Patent Application 63/426,528 filed 18 Nov. 2022; each of which is incorporated by reference herein for all purposes.

### TECHNICAL FIELD

This disclosure relates to various technologies for analysis of agricultural products.

### BACKGROUND

There is a final price that is respectively attributed to each agricultural product (e.g., an individual or a quantity of grains or seeds) when each agricultural product is respectively sold on a wholesale level. The final price may be determined by a perceived, predicted, inferred, extrapolated, or estimated quality of that respective agricultural product. The quality may be reflected by (i) a ratio/percentage of unbroken/whole agricultural products relative to broken/unwhole agricultural products, or vice versa; (ii) a ratio/percentage of foreign matter (e.g., straws, hulls, weeds, insects) perceived to be present relative to non-foreign matter, or vice versa; or (iii) a ratio/percentage of unhealthy, damaged, bug infested, eaten, peeled, molded, sprouted agricultural products relative to healthy, undamaged, bug non-infested, non-eaten, unpeeled, non-molded, non-sprouted agricultural products, or vice versa, some examples of which are illustrated in FIGS. 7-16 showing various agricultural products with different forms of damage. Further, the quality of that respective agricultural product is not informed by the quantity of foreign matter or of broken, unhealthy or insect damaged agricultural product, but by a ratio/percentage in physical weight that impurities or damages respectively represent.

Additionally, the quality of that respective agricultural product may also be determined by its varietal purity. For example, in a malting process, there is a step of steeping a quantity of barley and at least some uniformity in a variety of the quantity of barley is important for the malting process to be successful. Therefore, a malt producer performing the malting process needs to be confident that the quantity of barley that is being used in the malting process has a high percentage of varietal uniformity. Likewise, such varietal purity is also desired in soy seeds and wheat seeds because of its status as a strong indicator of agronomical and industrial/milling yield performance for those soy seeds or wheat seeds, while also enabling seed breeders to have a traceability record for their respective seeds or royalty collection.

Furthermore, most agricultural products are transported (e.g., ships, trucks, railcars) along various stages in various supply chains. As such, during such transportation, these agricultural products may (i) be mixed with other commodities, (ii) not be handled according to industry standards (or as required by regulation) or (iii) suffer environmental damages, among other hazards. Accordingly, for each receiver of those agricultural products along the stages in the supply chains, there is a desire to keep track of the agricultural products in terms of their quality or conditions. Currently, this occurs via various quality inspections at most or every stage of the supply chains. These inspections are helpful not only for determining the final price respectively attributed to each agricultural product when each agricultural product is sold on the wholesale level, but also for public health in context of food contamination, food recalls, food product withdrawals, disease outbreaks and safety alerts.

Based on above, there is no currently known technology to inspect agricultural products accurately, efficiently, cost-effectively, objectively, and expeditiously, with minimum manual labor. For example, conventionally, such inspections are manually conducted using naked eye, which is time-consuming, laborious, subjective, and expensive. Likewise, this approach requires a substantial amount of training and experience, which is time-consuming, laborious, expensive, and not always available (e.g., union strikes, labor shortages).

### SUMMARY

Various technologies disclosed herein solve various technological problems identified above by enabling various analysis of various agricultural products (e.g., an individual or a quantity of seeds, grains, pulses, legumes, beans) thereof. For example, there may be an apparatus or a component thereof, as disclosed herein. For example, there may be a device or a component thereof, as disclosed herein. For example, there may be a kit or a component thereof, as disclosed herein. For example, there may be a system including an apparatus, a device, a kit, a software logic, or a component thereof, as disclosed herein. For example, there may be a method of manufacture or use of a system, an apparatus, a device, a kit, a software logic, or a component thereof, as disclosed herein. For example, there may be a method of manufacturing or using a system, an apparatus, a device, a kit, a software logic, or a component thereof, as disclosed herein. For example, there may be a method of imaging, as disclosed herein. For example, there may be a method of processing an imagery, as disclosed herein. For example, there may be a method of presenting a user interface, as disclosed herein. For example, there may be a software logic or a component thereof, as disclosed herein. For example, there may be a memory storing a set of instructions executable by a processor to perform a method, as disclosed herein.

### DESCRIPTION OF DRAWINGS

FIG. 1A shows an embodiment of an apparatus in a closed configuration for imaging an agricultural product according to this disclosure.

FIG. 1B shows the apparatus of FIG. 1A in an open configuration to deposit or retrieve the agricultural product according to disclosure.

FIGS. 1C to 1T show a schematic diagram of the apparatus of FIGS. 1A and 1B according to this disclosure.

FIG. 2 shows a profile schematic view of the apparatus of FIGS. 1A configured to image an agricultural product according to this disclosure.

FIGS. 3-6 show various screenshots of image processing operations according to this disclosure.

FIG. 7-16 shows various images of agricultural products with different damages according to this disclosure.

FIG. 17-18 show various images of soy seeds according to this disclosure.

FIGS. 19-24 show various hilum colors according to this disclosure.

FIGS. 25-26 show a schematic diagram of the apparatus of FIGS. 1A and 1B in the closed configuration and the open configuration according to this disclosure.

FIGS. 27-32 shows various sectional schematic diagrams of the apparatus of FIGS. 1A and 1B according to this disclosure.

FIGS. 33-35 show various sectional schematic diagrams of the apparatus of FIGS. 1A and 1B with a panel according to this disclosure.

### DETAILED DESCRIPTION

Various technologies disclosed herein solve various technological problems identified above by enabling various analysis of various agricultural products (e.g., individual or quantity of seeds, grains, pulses, legumes, beans) thereof. In particular, various systems, apparatuses, devices, kits (e.g., ready-to-assemble (RTA)), software logic, methods, techniques, algorithms, and other modalities disclosed herein enable imaging (e.g., scanning) of the agricultural products, processing of such images, and taking various actions based on such processing. For example, some embodiments of these technologies enable digitization, segmentation, classification, and estimation of physical weights of the agricultural products, to respectively determine or aid in determining varietal purity or physical quality of each of those agricultural products or other related attributes, if that imagery satisfies or does not satisfy certain thresholds, which may be preset by a user. For example, some of such agricultural products may include individual or quantity of agricultural products, such as grains, seeds, pulses, legumes, beans, barley seeds, soy seeds, wheat seeds, corn seeds, or other types of suitable agricultural products, whether of one type or multiple types, whether of one variety or multiple varieties. For example, some systems, apparatuses, devices, kits, software logic, methods, techniques, algorithms, and other modalities enable identification of those agricultural products by various image processing technologies powered by various computer vision or machine learning algorithms. For example, some systems, apparatuses, devices, kits, software logic, methods, techniques, algorithms, and other modalities may include scanners (e.g., cameras, digital scanners, line scanners) to obtain or access the images of the agricultural products. For example, some images of the agricultural products may be formed or obtained by two scanners (e.g., one camera positioned above another camera when scanning, one camera vertically or diagonally opposing another camera when scanning). For example, one scanner (e.g., camera) may be used (e.g., a movable scanner circumnavigating around a volume, an area, or an object deposited on a surface, levitating, or blown to remain in air like a satellite along a trajectory). For example, one scanner (e.g., camera) may extend vertically or diagonally and another scanner (e.g., camera) may extend vertically or diagonally, such that these scanners (e.g., cameras) may vertically or diagonally oppose each other when scanning, which may occur when some or both of these scanners (e.g., cameras) are positionally fixed and a scanned object (e.g., an agricultural product) is vertically or diagonally moving therebetween (e.g., freefalling, gravitationally, conveyor, elevator). For example, at least three scanners (e.g., cameras) are possible (e.g., top-bottom-front, top-bottom-front-back). For example, if there are at least two scanners (e.g., cameras) positionable one above another when scanning, then one scanner (e.g., a camera) may be a bottom scanner (e.g., a camera) facing upwards to scan thereon and another scanner (e.g., a camera) may be a top scanner (e.g., a camera) facing downwards to scan thereunder, where an agricultural product that will be analyzed is placed on the scanning area of the bottom scanner (e.g., a camera) after moving (e.g., sliding backwards, pivoting upwards) the top scanner (e.g., a camera), or vice versa. Once the agricultural product is placed on the scanning area of the bottom scanner, the top scanner (e.g., a camera) is moved (e.g., sliding forwards, pivoting downwards), leaving the agricultural product between the two scanners (e.g., cameras) and thereby enabling formation of two images (or two sets of images) of the agricultural product: one image (or set of images) from above by the top scanner (e.g., a camera) and one image (or set of images) from below from the bottom scanner (e.g., a camera). Then, the two images (or two sets of images) are transferred to an application program running on an operating system (OS) of a computing terminal (e.g., a desktop computer, a tablet computer, a smartphone computer, a wearable computer, a vehicular computer, a kiosk computer), where the application program processes the two images (or two sets of images) with various algorithms (e.g., computer vision, machine learning), as disclosed herein. Then, the application program presents a graphical user interface presenting a screen or a set of screens with a result or a set of results formed based on those algorithms. Therefore, such scanning technology may enable (i) imaging of the agricultural product from above and from below (or otherwise two opposing viewpoints) relatively or substantially simultaneously or in one action while being packaged in a manageable, small, portable, or compact form factor; (ii) imaging of the agricultural product with controlled background colors with minimum or no reflections; (iii) imaging of the agricultural product from both sides occurring relatively or substantially simultaneously; or (iv) imaging of the agricultural product being done with optimum quality, allowing the application program to make a proper analysis complying with (or even exceeding) at least some industry standards. Note that although the application program is installed on the computing terminal, this configuration is not required and the application program can be cloud-based and accessible via a network connection (e.g., Wi-Fi, Ethernet, cellular towers, satellite, 5G) via another application program (e.g., a browser application program, a dedicated application program, a browser extension, a productivity suite application or an add-on thereto) running on the OS of the computing terminal. Likewise, although this disclosure is further detailed below in context of classification of different types or varieties of agricultural products, whether an individual or a quantity, such as seeds, fruit seeds, vegetable seeds, grains, pulses, legumes, beans, barley seeds, buckwheat, soy seeds, wheat seeds, corn seeds, nuts, acorns, chestnuts, cashews, peanuts, walnuts, rice particles, or other suitable agricultural products, this disclosure is not limited to these agriculture products and can be used to classify other agricultural products, which may include different fruits (e.g., apples, tomatoes, berries, cucumbers, peppers, olives, eggplant, avocados, pomegranates), vegetables (e.g., potatoes, carrots, cabbage, onions, garlic), cereals (e.g., corn flakes), and other suitable agricultural products, whether an individual or a quantity, whether natural or synthetic. Similarly, this disclosure is not limited to agricultural products and can be used for non-agricultural products (e.g., marbles, beads, tablets, pills, capsules, stones, gemstones, rocks, pebbles), whether an individual or a quantity.

This disclosure is now described more fully with reference to figures included herein, in which some embodiments of this disclosure are shown. This disclosure may, however, be embodied in many different forms and should not be construed as necessarily being limited to the embodiments disclosed herein. Rather, these embodiments are provided so that this disclosure is thorough and complete, and fully conveys various concepts of this disclosure to skilled artisans.

Various terminology used herein can imply direct or indirect, full or partial, temporary or permanent, action or inaction. For example, when an element is referred to as being “on,” “connected,” or “coupled” to another element, then the element can be directly on, connected, or coupled to another element or intervening elements can be present, including indirect or direct variants. In contrast, when an element is referred to as being “directly connected” or “directly coupled” to another element, then there are no intervening elements present.

As used herein, various singular forms “a,” “an” and “the” are intended to include various plural forms (e.g., two, three, four, five, six, seven, eight, nine, ten, tens, hundreds, thousands) as well, unless specific context clearly indicates otherwise.

As used herein, various presence verbs “comprises,” “includes” or “comprising,” “including” when used in this specification, specify a presence of stated features, integers, steps, operations, elements, or components, but do not preclude the presence or addition of one or more other features, integers, steps, operations, elements, components, or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

As used herein, unless otherwise defined, all terms (including technical and scientific terms) used herein have the same meaning as commonly understood by one of ordinary skills in an art to which this disclosure belongs. Various terms, such as those defined in commonly used dictionaries, should be interpreted as having a meaning that is consistent with a meaning in a context of a relevant art and should not be interpreted in an idealized or overly formal sense unless expressly so defined herein.

As used herein, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” or “substantially” refers to a +/−10% variation from a nominal value/term. Such variation is always included in any given value/term provided herein, whether or not such variation is specifically referred thereto.

As used herein, a term “or others,” “combination”, “combinatory,” or “combinations thereof” refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. Skilled artisans understand that typically there is no limit on a number of items or terms in any combination, unless otherwise apparent from the context.

Although the terms first, second, can be used herein to describe various elements, components, regions, layers, or sections, these elements, components, regions, layers, or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Features or functionality described with respect to certain embodiments may be combined or sub-combined in or with various embodiments in any permutational or combinatorial manner. Different aspects or elements of embodiments, as disclosed herein, may be combined or sub-combined in a similar manner.

Some embodiments, whether individually or collectively, can be components of a larger system, where other procedures can take precedence over or otherwise modify their application. Additionally, a number of steps can be required before, after, or concurrently with embodiments, as disclosed herein. Note that any or all methods or processes, at least as disclosed herein, can be at least partially performed via at least one entity in any manner.

Some embodiments are described herein with reference to illustrations of idealized embodiments (and intermediate structures) of this disclosure. As such, variations from various illustrated shapes as a result, for example, of manufacturing techniques or tolerances, are to be expected. Thus, various embodiments should not be construed as necessarily limited to various particular shapes of regions illustrated herein, but are to include deviations in shapes that result, for example, from manufacturing.

Any or all elements, as disclosed herein, can be formed from a same, structurally continuous piece, such as being unitary, or be separately manufactured or connected, such as being an assembly or modules. Any or all elements, as disclosed herein, can be manufactured via any manufacturing processes, whether additive manufacturing, subtractive manufacturing, or any other types of manufacturing. For example, some manufacturing processes include three dimensional (3D) printing, laser cutting, computer numerical control routing, milling, pressing, stamping, vacuum forming, hydroforming, injection molding, lithography, and so forth.

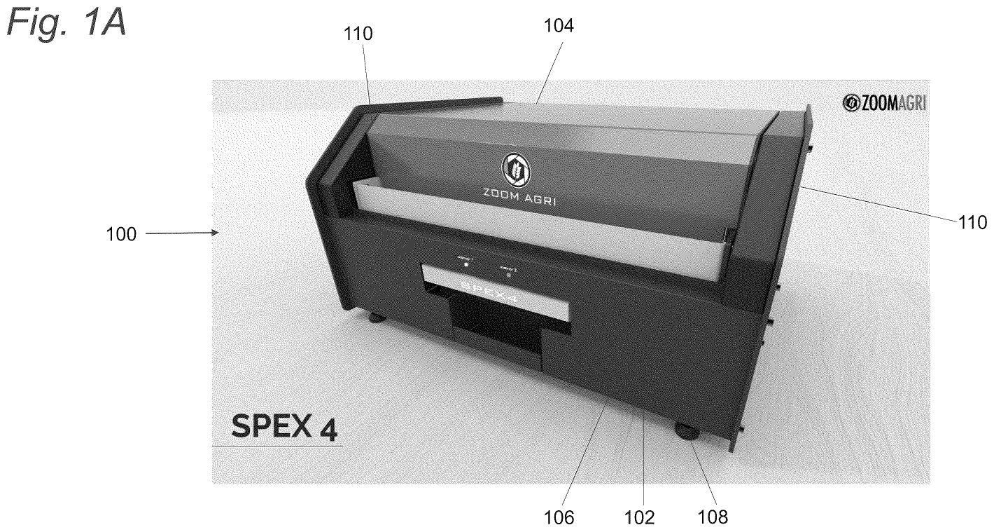

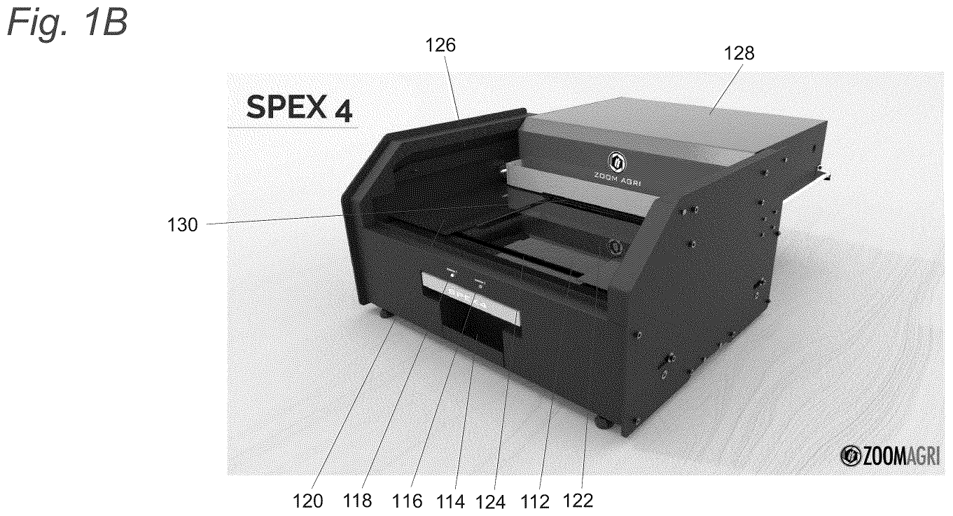

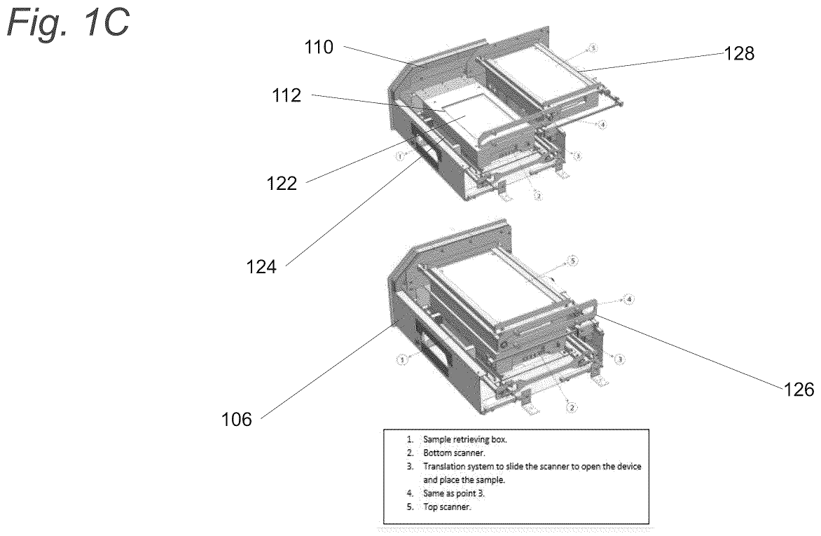

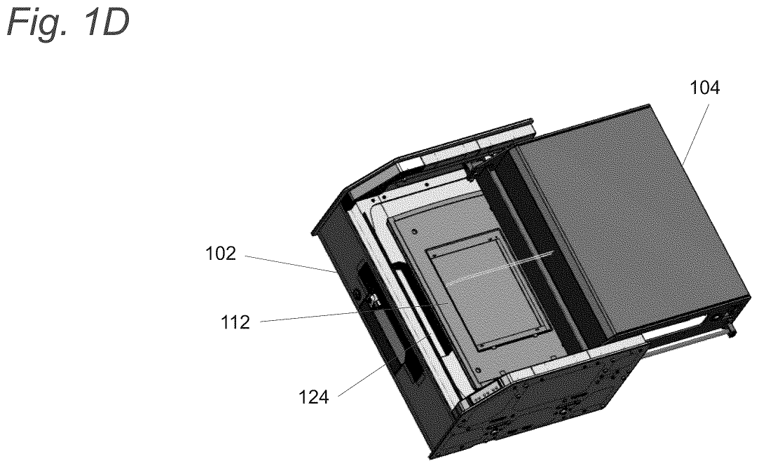

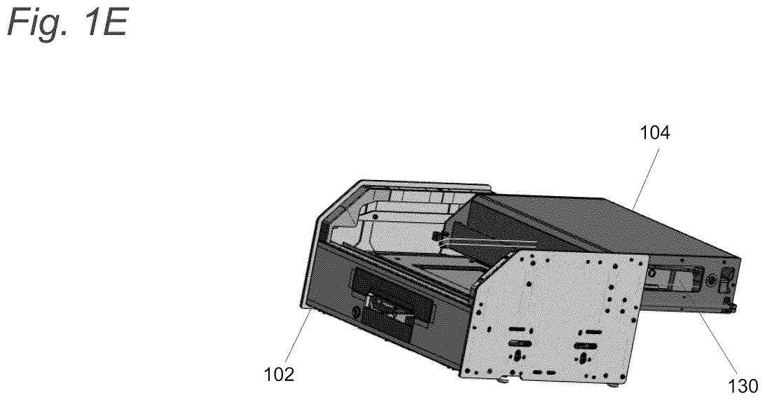

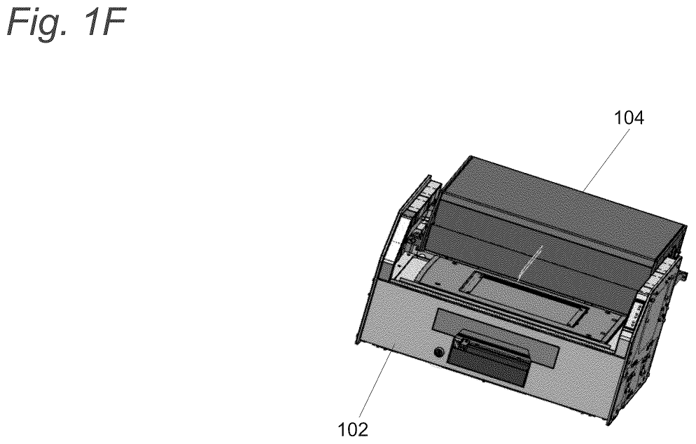

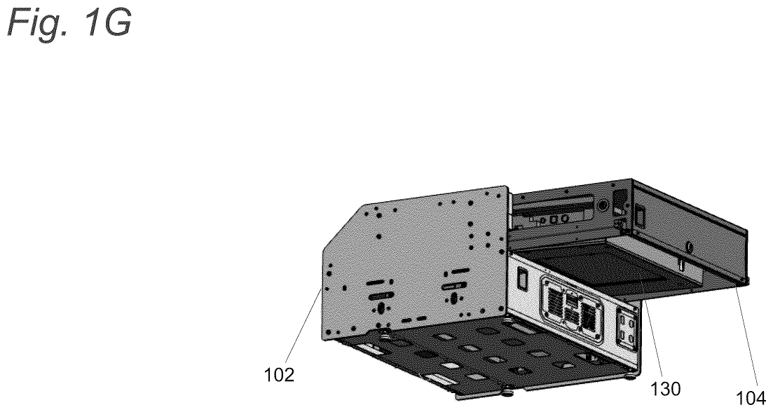

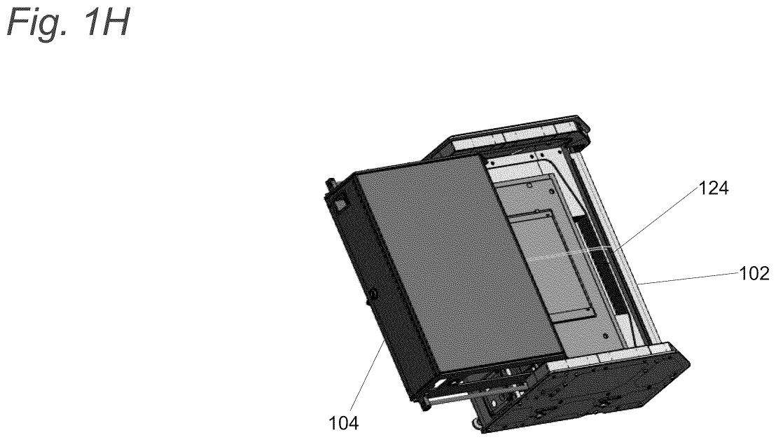

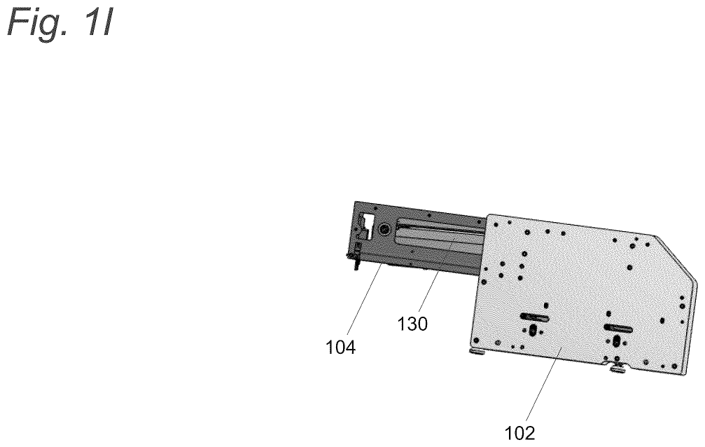

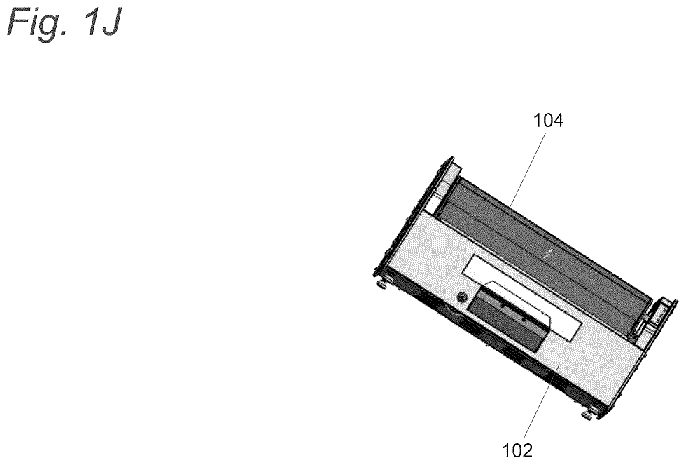

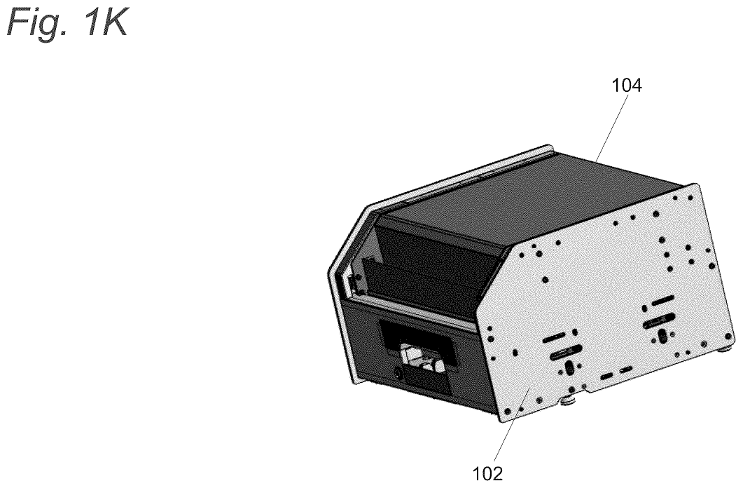

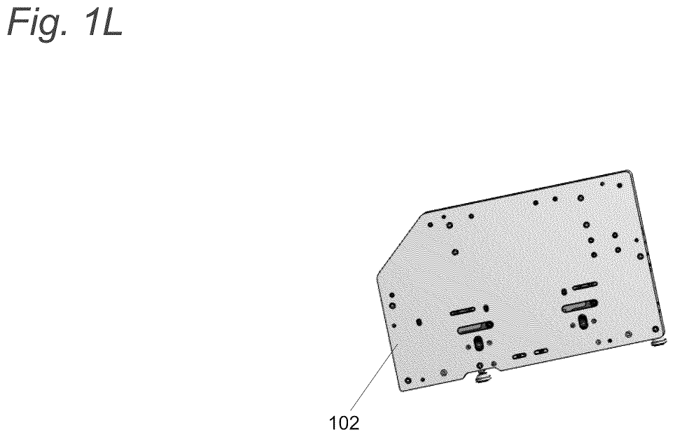

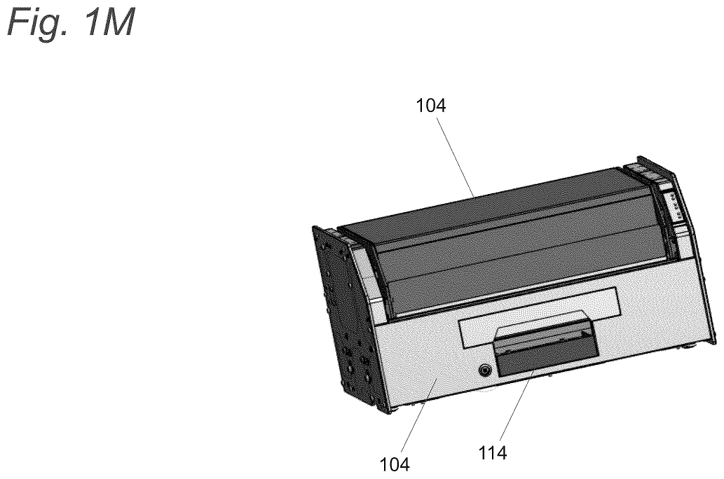

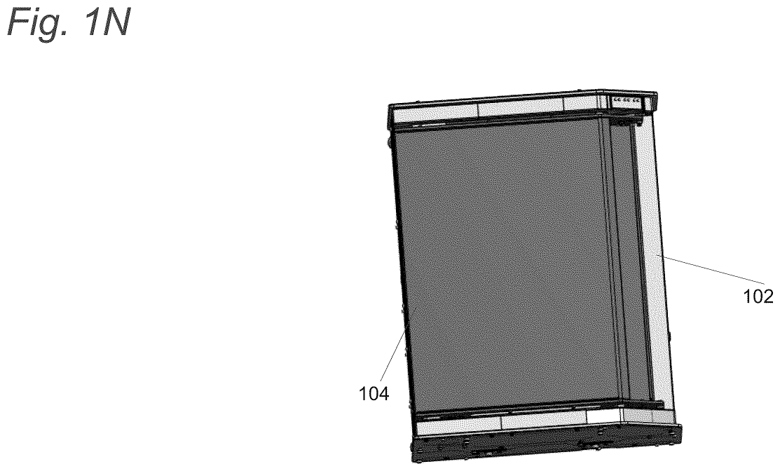

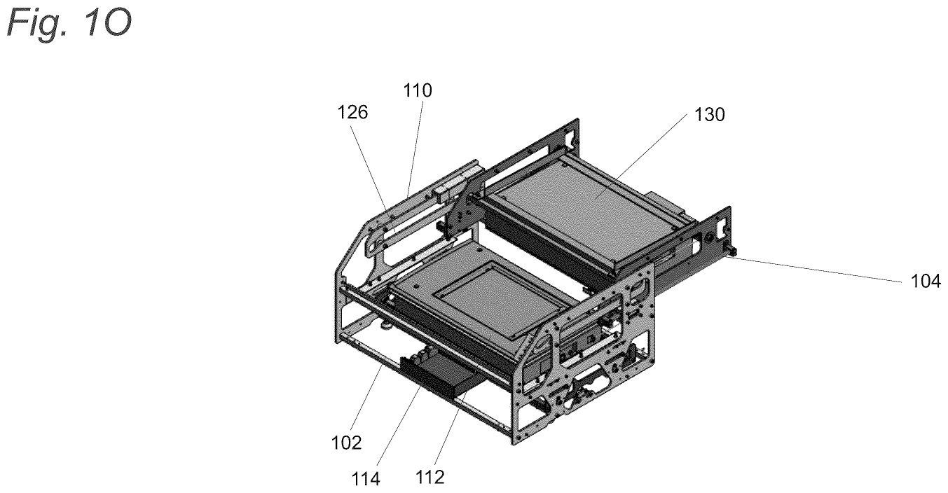

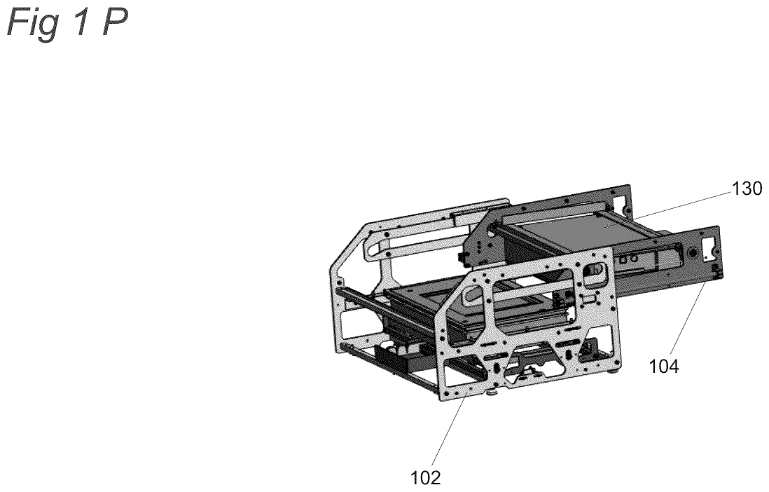

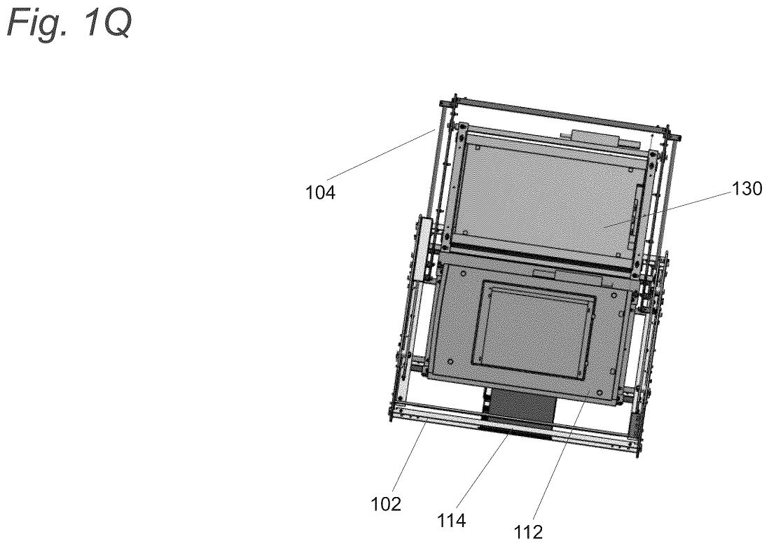

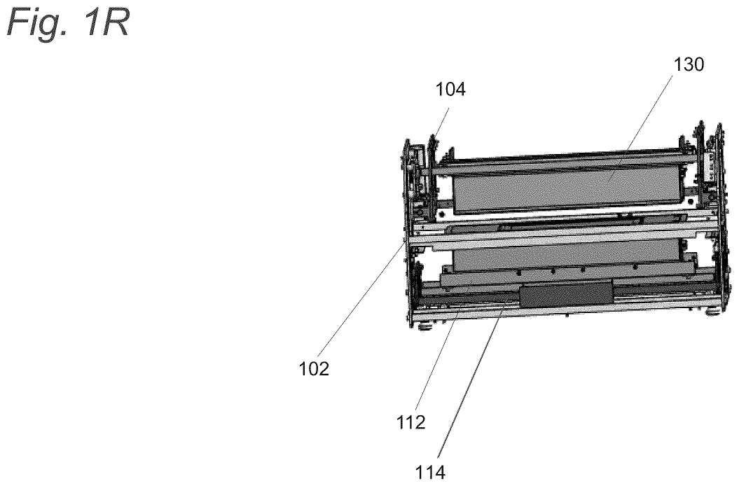

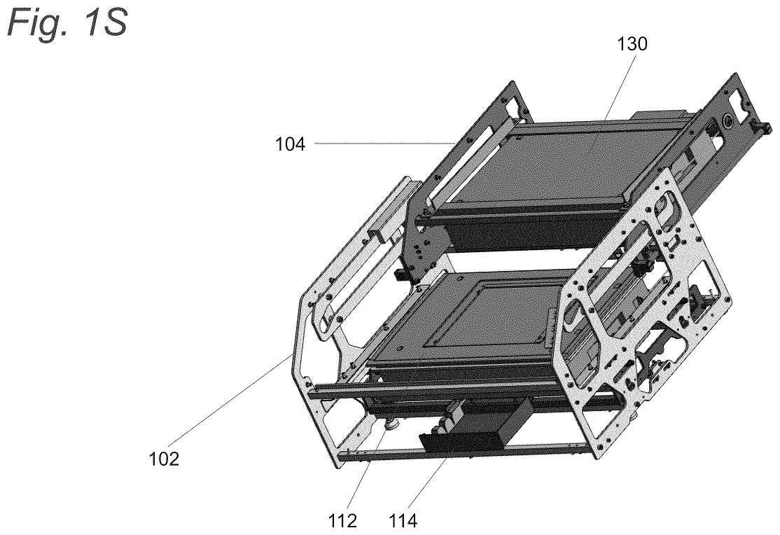

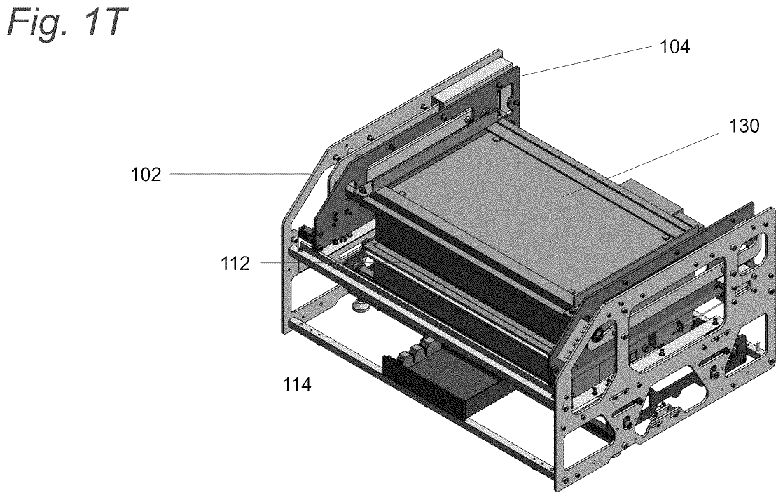

FIG. 1A shows an embodiment of an apparatus in a closed configuration for imaging an agricultural product according to this disclosure. FIG. 1B shows the apparatus of FIG. 1A in an open configuration to deposit or retrieve the agricultural product according to disclosure. FIGS. 1C to 1T show a schematic diagram of the apparatus of FIGS. 1A and 1B according to this disclosure. In particular, there is an apparatus 100, which may be used for imaging an agricultural product, whether an individual or a quantity, such as seeds, fruit seeds, vegetable seeds, grains, pulses, legumes, beans, barley seeds, buckwheat, soy seeds, wheat seeds, corn seeds, nuts, acorns, chestnuts, cashews, peanuts, walnuts, or other suitable agricultural products.

The apparatus 100 may have a power cable tailing therefrom. The power cable, which may be configured to transfer data to or from the apparatus 100, is connectable to a socket or a receptacle of a mains electricity source (e.g., a wall plug, an extension cord), to power various electrical components of the apparatus 100, as disclosed herein.

The apparatus is scaled to have between about 3 feet and about 8 feet in length (front to rear or vice versa), between about 4 feet and about 6 feet in height (bottom to top or vice versa), and between about 3 feet and about 8 feet in width (right to left or vice versa), weighing between about 200 pounds and about 1000 pounds. However, note that such scale is not required and each dimension mentioned above (length, height, width, weight) may vary, whether higher or lower, whether inside each respective range or outside of each respective range, each dimension independent of another.

The apparatus 100 is illustrated to be a freestanding appliance, whether in a building (e.g., a laboratory, a warehouse, a university or school building, an office building, a commercial building, a residential building) or a vehicle, whether land, aerial, or marine (e.g., a car, a truck, a van, a bus, a railcar, a helicopter, an airplane, a boat, a submarine). However, note that this configuration is not required and the apparatus 100 may be integrated into or be a component of another object or system.

For example, the apparatus 100 may be integrated into a wall to be a kiosk, whether in a building (e.g., a laboratory, a warehouse, a university or school building, an office building, a commercial building, a residential building) or a vehicle, whether land, aerial, or marine (e.g., a car, a truck, a van, a bus, a railcar, a helicopter, an airplane, a boat, a submarine).

As disclosed herein, the apparatus 100 includes a base portion 102 and a top portion 104, any of which may be omitted. The base portion 102 includes a housing 106, a plurality of legs 108, a pair of walls 110, a scanning unit 112, a compartment 114, a visual indicator 116, and a visual indicator 118, any of which may be omitted. The housing 106 has a top side 120, which may be omitted. The housing 106 hosts the scanning unit 112, which may be omitted. The scanning unit 112 includes a scanning area 122 extending along the top side 120, any of which may be omitted. The housing 106 and the scanning unit 112 are spaced apart from each other to form a gap 124 therebetween, any of which may be omitted. The pair of walls 110 include a pair of tracks 126, which may be omitted. The top portion 104 includes a housing 128 and a scanning unit 130, any of which may be omitted. The housing 128 hosts the scanning unit 130, which may be omitted. Note that any of these components may be adapted for different scanning modalities, as explained above. For example, the scanning unit 112 and the scanning unit 130 may oppose each other along a horizontal plane, a vertical plane, or a diagonal plane when scanning. For example, if one scanning unit is involved, as described above, then that scanning unit may be the scanning unit 112 or the scanning unit 130. For example, if two scanning units are involved, as described above, then those scanning units may be the scanning unit 112 and the scanning unit 130. For example, if three or more scanning units are involved, as described above, then those scanning units may be any one or any suitable combination of the scanning unit 112 or the scanning unit 130. Although the scanning unit 112 and the scanning unit 130 are depicted in FIGS. 1A to 1T to oppose each other along a horizontal plane when scanning, this configuration is not required and the scanning unit 112 and the scanning unit 130 may oppose each other along a vertical plane or a diagonal plane when scanning. Other components, their positions, or orientations may be suitably adapted accordingly.

The power cable may tail from the base portion 102 or the top portion 104. Alternatively, the apparatus 100 may be powered by a battery (e.g., lithium ion, nickel-cadmium), which may be rechargeable, to power various electrical components of the apparatus 100, as disclosed herein. For example, the apparatus may house the battery, whether internally or externally, or the battery may be positioned off the apparatus 100, but still powering the apparatus 100.

As shown in FIGS. 1O to 1T, the housing 106 includes a frame (e.g., metal, plastic) having a pair of sidewalls (e.g., metal, plastic) opposing each other, a pair of frontal brackets (e.g., metal, plastic), extending one above another, spanning between the pair of sidewalls, and a pair of rear brackets (e.g., metal, plastic), extending one above another, spanning between the pair of sidewalls, although the frame may be omitted. For ease of understanding, the frame is shown in yellow in FIG. 1O and others. The pair of sidewalls, the pair of frontal brackets, and the pair of rear brackets are assembled with each other (e.g., by fastening, mating, interlocking), individually or collectively, although the pair of sidewalls, the pair of frontal brackets, and the pair of rear brackets can be monolithic with each other, individually or collectively. As shown in FIGS. 1A to 1N, the frame is covered with a skin (e.g., sheets, plastic sheets, metal sheets, fabric, panels, plastic panels, metal panels), along the pair of sidewalls, the pair of frontal brackets, and the pair of rear brackets, whether the skin is a single piece or an assembly pieces. The skin is assembled with the frame by fastening (e.g., bolts, screws) thereto, although other suitable ways are possible (e.g., mating, interlocking, riveting, adhering, magnetizing, stitching), or the skin can be monolithic with the frame. As shown in FIGS. 1A to 1N, the housing 106 is shaped as a cuboid, although other shapes are possible (e.g., a cube, a ovoid, a pyramid). The skin may be omitted.

As shown in FIGS. 1A to 1B, the housing 106 is supported by the legs 108, positioned at each underside corner thereof (when corners are present), although other positioning arrangements are possible (e.g., triangular, pentagram, pentagon, heptagram, hexagon). The legs 108 are fastened to the housing 106 (e.g., to the frame or the skin at its underside), although other ways of securing the legs 108 to the housing 106 are possible (e.g., mating, adhering, interlocking) or at least some of the legs 108 may be monolithic with the housing 106. The legs 108 may be of a fixed height or height-adjustable, each independent of another, to allow the housing 106 to remain stable and minimize wobbling if at least some of the legs 108 stand on a surface that is not level or flat. The legs 108 avoid caster wheels, but the legs 108 may include a plurality of caster wheels, which may include rollers or spheres, any of which may be motorized. For example, a pair of front legs 106, a pair of rear legs 106, or all legs 106 may each include a caster wheel or a pair of caster wheels, although mix-and-matching is possible (some are equipped with caster wheels and some are not equipped with caster wheels). The legs 108 may be omitted.

The pair of walls 110 (e.g., metal, plastic) extend from the pair of sidewalls of the frame of the housing 106, between the pair of frontal brackets of the frame of the housing 106 and the pair of the rear brackets of the frame of the housing 106. For example, if the base portion 102 rests on a surface that is flat or level, then the pair of walls 110 extend up from the pair of sidewalls of the frame of the housing 106, away from the surface, along a vertical plane. The pair of walls 110 are covered with the skin, as described above. The pair of walls 110 are spaced apart from and oppose each other to form an open space therebetween, above the housing 106. As shown in FIG. 1B, the top side 120, which includes the scanning unit 112 (e.g., a top surface thereof), extends in the open space, between the pair of walls 110, spanning the pair of walls 110, such that the pair of walls 110 and the top side 120 form a U-shape. The pair of walls 110 may be omitted.

As shown in FIGS. 1B and 1O, the pair of walls 110 host the pair of tracks 126 (e.g., rails, slots, guides) that extend between the pair of frontal brackets of the frame of the housing 106 and the pair of the rear brackets of the frame of the housing 106, whether front to rear or rear to front. The pair of tracks 126 are raised above the top side 120 if the base portion 102 rests on a surface that is flat or level. The pair of tracks 126 may be rectilinear, inclined, whether toward front or rear, or have another suitable shape. For example, if the base portion 102 rests on a surface that is flat or level, then each of the pair of tracks 126 may be hockey-stick shaped, curved, or bent downward in front, toward the surface, along a vertical plane, which enables up and back sliding movement of the top portion 104 from the closed configuration to the open configuration and vice versa, as further described below. The pair of tracks 126 may be omitted.

The scanning unit 112 is an enclosure that contains a scanner (e.g., a camera, a color scanner, a high-resolution scanner, a line scanner). For example, the scanner may have a scanning head that moves (e.g., by a motor or an actuator), whether front-to-rear, rear-to-front, right-to-left, left-to-right, or another suitable way, and images during such movement, as further described below. For ease of understanding, the scanning unit 112 is shown in green in FIG. 1O. As shown in FIG. 1B, the top side 120 includes the scanning unit 112. The scanning unit 112 includes the scanning area 122 extending along the top side 120. The scanning area 122 includes a glass area (e.g., a scanning tabletop) underneath and along which the scanner moves and through which the scanner scans an agricultural product (or another object) disposed thereon. The glass area may be hardened (e.g., plexiglass) to withstand impact when the agricultural product may scratch, dent, fracture, or otherwise damage the glass area. The glass area is smooth, but may be textured. The scanning unit 112 may be omitted.

As shown in FIGS. 1B and 1O, the compartment 114 is frontally positioned between the pair of sidewalls of the frame of the housing 106, adjacent to the pair of frontal brackets of the frame of the housing 106, below the top side 120. The compartment 114 is shaped to be cuboid, but other suitable shaping is possible (e.g., cube, ovoid, pyramidal). The housing 106 houses the compartment 114 disposed below the top side 120, the scanning unit 112, the scanning area 122, or the glass area. For example, the compartment 114 may be positioned between the pair of frontal brackets of the frame of the housing 106, although this configuration is not required and the compartment 114 can be positioned above or below one frontal bracket of the pair of frontal bracket or the pair of frontal brackets, or one rear bracket of the pair of rear brackets or the pair of rear brackets. Likewise, although the compartment 114 is shown to be frontally positioned between the pair of sidewalls of the frame of the housing 106, this configuration is not required and the compartment 114 can be rear positioned between the pair of sidewalls of the frame of the housing 106 or along one of the sidewalls of the frame of the housing 106. The compartment 114 may be omitted.

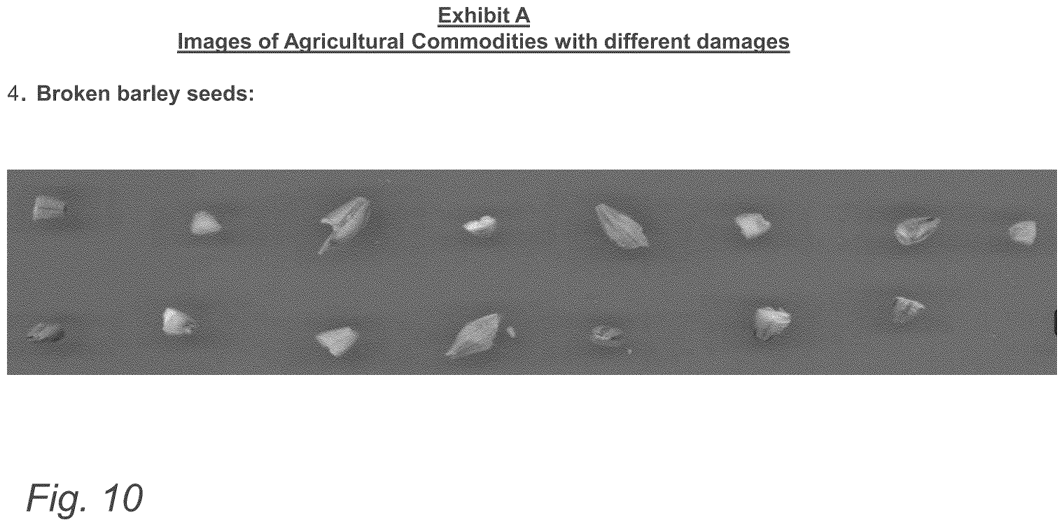

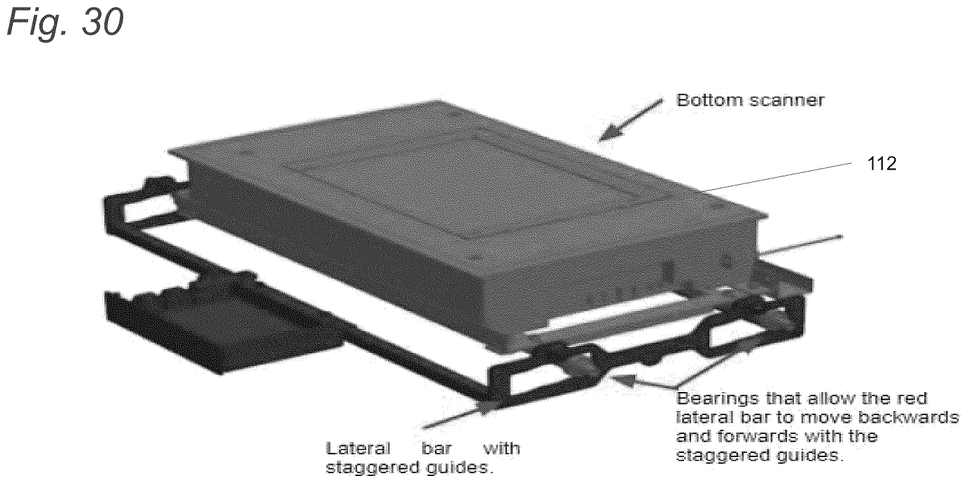

The compartment 114 leads into a box (or another suitable container or pocket form factor) with a top portion open toward the top side 120, when the box is positioned with the housing 106. For ease of understanding, the box is shown in red in FIG. 10. The box may be movable (e.g., selectively, programmatically) out of the compartment 114 and into the compartment 114, whether manually (e.g., by pulling and pushing) or automatically (e.g., by a motor or an actuator). For example, as shown in FIGS. 30-32, the housing 106 may contain a frame (also shown in red) connected to the box, although the frame may be omitted. The frame may have a frontal member (e.g., a bar), a pair of sidewalls, each having a pair of projections extending (e.g., monolithically, assembled) outwardly towards the pair of sidewalls of the frame of the housing 106, and a rear member (e.g., a bar). Each of the frontal member and the rear member span between the pair of sidewalls, where the frontal member is attached, connected, or monolithic with the box, at its rear side or another suitable side (or the box is attached, connected, or monolithic with the rear member). Correspondingly, the pair of sidewalls of the frame of the housing 106 host a pair of tracks (e.g., rails, slots, guides) that extend between the pair of frontal brackets of the frame of the housing 106 and the pair of the rear brackets of the frame of the housing 106, whether front to rear or rear to front. The pair of tracks extend below the pair of tracks 126 and below the top side 120 if the base portion 102 rests on a surface that is flat or level. The tracks may be rectilinear, inclined, whether toward front or rear, or have another suitable shape. The pair of projections extend (e.g., cantileveredly) from the pair of sidewalls, while the frame is attached, connected, or monolithic with the box, at its rear side. As such, the pair of projections extend within the tracks of the pair of sidewalls of the frame of the housing 106, such that the pair of projections engage the tracks of the pair of sidewalls of the frame of the housing 106. Therefore, the box, along with the frame, are slidably movable out of and into the compartment 114 relative to the frame of the housing 106. For example, the box may be slidable out of the compartment 112, away from the frontal brackets of the frame of the housing 106, and into the compartment 114, toward the frontal brackets of the frame of the housing 106, along the frame of the housing 106. The box may have a bottom inner side that is not covered by any material (e.g., in its raw material state) or the box may have the bottom inner side covered with a material (e.g., silencing material, cloth, fabric, foam, felt, leather), to minimize noise, when an agricultural product is deposited thereinto, as further described below. The box may be omitted.

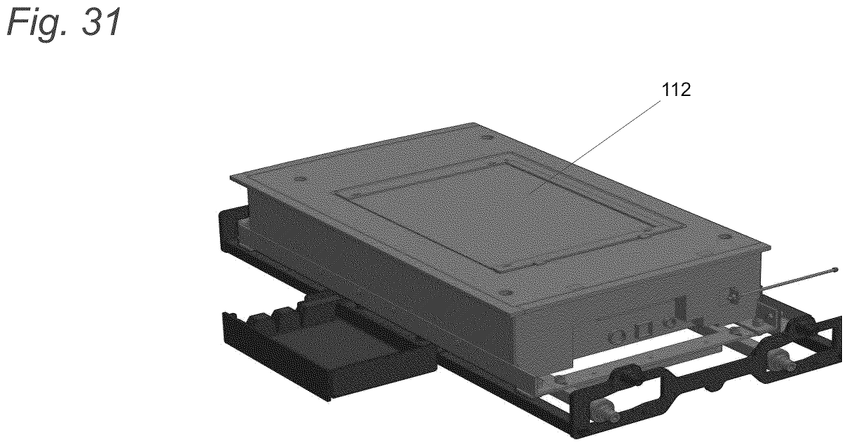

As shown in FIGS. 1O to 1T and 31, the scanning unit 112 optionally has a pair of projections (e.g., cantilevered), on each lateral side, engaging the frame connected, attached, or monolithic with the box, between the frontal member and the rear member, to enable the scanning unit 112 to move (e.g., travel) relative to the frame connected, attached, or monolithic with the box. The pair of projections, on each lateral side, of the scanning unit 112 further engage the frame of the housing 106, to enable the scanning unit 112 to move (e.g., travel) relative to the frame of the housing 106. Likewise, the frame connected, attached, or monolithic with the box optionally has a pair of projections (e.g., cantilevered), on each lateral side, engaging the frame of the housing 106, to enable the frame connected, attached, or monolithic with the box to move (e.g., travel) relative to the frame of the housing 106, as described above.

The visual indicator 116 visually indicates when the scanning unit 112 is operating. The visual indicator may include a light source, such as a light emitting diode (LED), an incandescent bulb, a gas discharge lamp, or another suitable light source, which may be powered as described above. The visual indicator 116 may be omitted.

The visual indicator 118 visually indicates when the scanning unit 130 is operating. The visual indicator may include a light source, such as a light emitting diode (LED), an incandescent bulb, a gas discharge lamp, or another suitable light source, which may be powered as described above. The visual indicator 118 may be omitted.

As shown in FIGS. 1C, 1D, 1H, the housing 106 has a hollow shaft (e.g., a tube, a tubular member, a conduit, a channel, a tunnel, a slide, an absence of matter) spanning between the gap 124 and the box, when the box is positioned in the compartment 114. The hollow shaft is rectilinear, although other suitable forms of extensions (e.g., helical, spiral, sinusoidal, concave, convex) are possible. The hollow shaft has a rectangular cross-section, although other suitable cross-sectional shapes (e.g., circular, oval, triangular, square, pentagonal, teardrop) are possible. The hollow shaft has an internal flat or smooth surface, although a textured surface is possible. If the base portion 102 rests on a surface that is flat or level, then the hollow shaft extends along a vertical plane between the gap 124 and the box, when the box is positioned in the compartment 114. When the box is not positioned within the compartment 114, then the hollow shaft spans between the gap 124 and the compartment 114, within the housing 106. The hollow shaft may be omitted.

As shown in FIGS. 1B, 1C, 1O, and 1P, the gap 124 extends adjacent to the scanning unit 112, between the pair of sidewalls 110, above the compartment 114. The gap 124 is shaped to be rectangular, but other suitable shapes are possible (e.g., square, oval, triangle). The box is positioned underneath the gap 124, within the compartment 114, when the box is positioned inside the housing 106, such that an agricultural product can be evacuated or urged (e.g., swept, brushed, blown, suctioned, slid) into the gap 124, be input (e.g., fall) into the hollow shaft, fall (e.g., freefall) within the hollow shaft, and output from the hollow shaft into the box, after the agricultural product is scanned, as further described below. For example, after the agricultural product is scanned, a person may hold and operate a brush to sweep the agricultural product into the gap 124, such that the agricultural product falls into the box via the hollow shaft, and then pull out box from the compartment 114 to withdraw the agricultural product from the box. For example, the housing 106 may host a brush, whether driven by a motor or an actuator, each housed by the housing 106, to sweep the agricultural product into the gap 124, such that the agricultural product falls into the box via the hollow shaft, and then pull out box from the compartment 114 to withdraw the agricultural product from the box. For example, the brush may be a rotary brush. For example, the frame of the housing 106 or the skin thereof, or the top side 120, or the scanning unit 112, or the pair of walls 110, or the housing 128 may host (e.g., fastened, mated) the brush. For example, after the agricultural product is scanned, a person may blow or suction or hold and operate a fan (e.g., an impeller, a blower, an air knife, a suction) to move, whether by positive pressure or negative pressure, the agricultural product into the gap 124, such that the agricultural product falls into the box via the hollow shaft, and then pull out box from the compartment 114 to withdraw the agricultural product from the box. For example, the housing 106 may host the fan, whether driven by a motor or an actuator, each housed by the housing 106, to move the agricultural product into the gap 124, such that the agricultural product falls into the box via the hollow shaft, and then pull out box from the compartment 114 to withdraw the agricultural product from the box. For example, the frame of the housing 106 or the skin thereof, or the top side 120, or the scanning unit 112, or the pair of walls 110, or the housing 128 may host (e.g., fastened, mated) the fan. Although the agricultural product is described to fall (e.g., freely or gravitationally) within the hollow shaft, this configuration is not required and the hollow shaft may host an elevator or a conveyor, each powered by a motor or an actuator attached to the housing 106, to transport the agricultural product from the gap 124 to the box. The gap 124 may be omitted.

As shown in FIGS. 1E to 1T, the top portion 104 includes the housing 128 hosting the scanning unit 130. For ease of understanding, the housing 128 is shown in purple and the scanning unit 112 is shown in blue in FIGS. 1E to 1T. The housing 128 includes a frame (e.g., metal, plastic) having a pair of sidewalls (e.g., metal, plastic) opposing each other, a frontal panel (e.g., metal, plastic), spanning between the pair of sidewalls, a rear panel (e.g., metal, plastic), spanning between the pair of sidewalls, and a top (e.g., roof, ceiling) panel (e.g., metal, plastic), spanning between the pair of sidewalls. The pair of sidewalls, the frontal panel, the rear panel, and the top panel are assembled with each other (e.g., by fastening, mating, interlocking), individually or collectively, although the pair of sidewalls, the frontal panel, the rear panel, and the top panel can be monolithic with each other, individually or collectively.

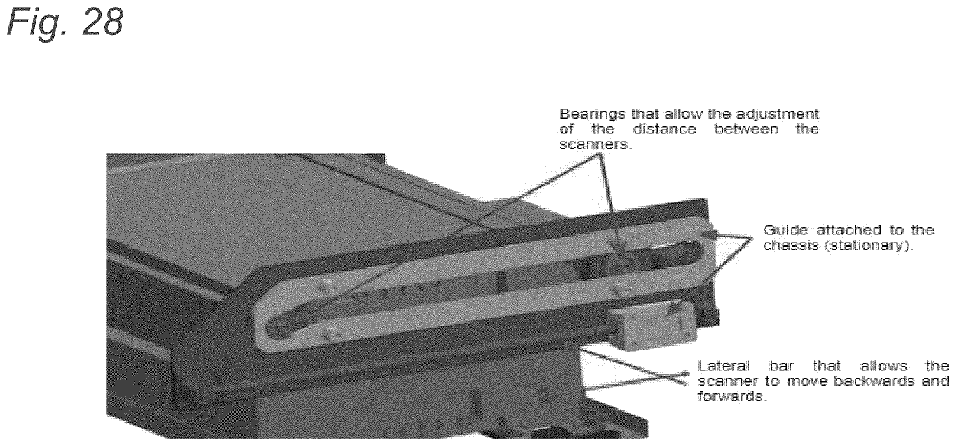

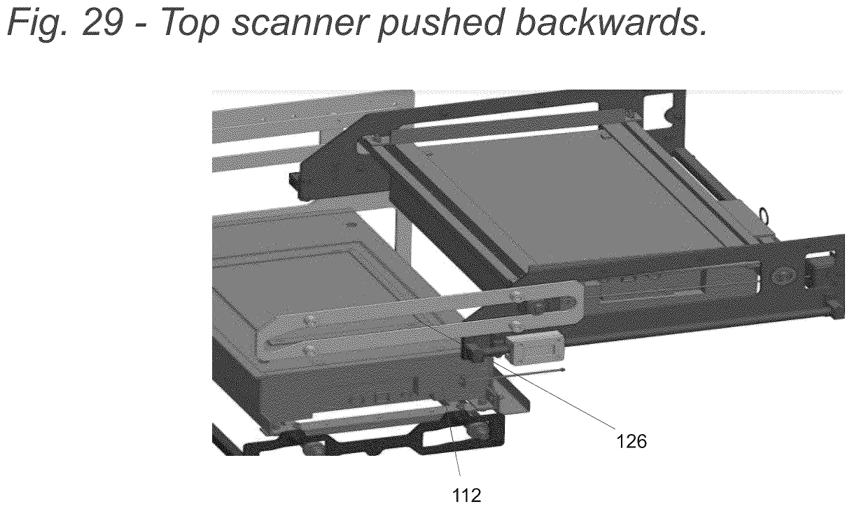

As shown in FIGS. 1A to 1N, the frame is covered with a skin (e.g., sheets, plastic sheets, metal sheets, fabric, panels, plastic panels, metal panels), along the pair of sidewalls, the frontal panel, the rear panel, and the top panel, whether the skin is a single piece or an assembly pieces. The skin is assembled with the frame by fastening (e.g., bolts, screws) thereto, although other suitable ways are possible (e.g., mating, interlocking, riveting, adhering, magnetizing, stitching), or the skin can be monolithic with the frame. As shown in FIGS. 1A to 1N, the housing 128 is shaped as a cuboid, although other shapes are possible (e.g., a cube, a ovoid, a pyramid). As shown in FIGS. 28 and 29, the pair of sidewalls each has a guide to enable the housing 128 to move (e.g., travel) along the pair of tracks 126. The housing 128 may be omitted.

The scanning unit 130 is an enclosure that contains a scanner (e.g., a camera, a color scanner, a high-resolution scanner, a line scanner), whether identical or non-identical in type, version, configuration, or other suitable operational modality of the scanning unit 112, whether more or less advanced in imaging quality, speed, imaging direction, or other suitable operational modality. For example, the scanner may have a scanning head that moves (e.g., by a motor or an actuator), whether front-to-rear, rear-to-front, right-to-left, left-to-right, or another suitable way, and images during such movement, as further described below. The scanning unit 130 includes an underside having a glass area (e.g., a scanning tabletop if flipped upside down) over which and along which the scanner moves and through which the scanner scans an agricultural product (or another object) disposed thereon. The glass area may be hardened (e.g., plexiglass) to withstand impact when the agricultural product may scratch, dent, fracture, or otherwise damage the glass area. The glass area is smooth, but may be textured. The scanning unit 130 may be omitted.

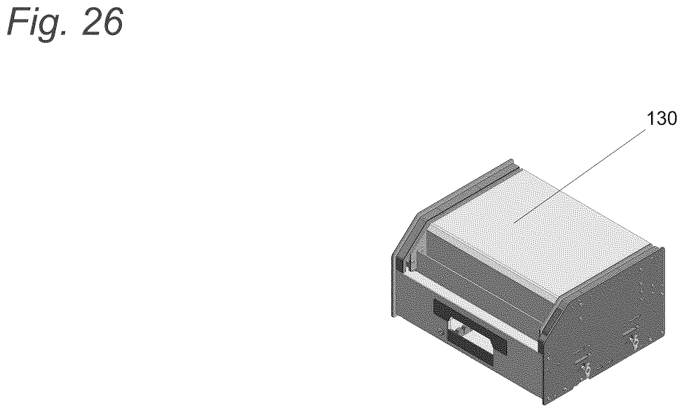

As shown in FIGS. 1C, 1O to 1T, and 25-32, the scanning unit 130 has a pair of projections extending outwardly therefrom, on each respective lateral side, each hosting a bearing. The projections, along with respective bearings, respectively engage the pair of sidewalls of the frame of the housing 128 and the pair of tracks 126, to enable the scanning unit 130 to move from rear to front (the closed configuration) and front to rear (the open configuration).

The scanning unit 112 and the scanning unit 130 may be spaced apart from each other, during scanning, at a distance (e.g., about 1 inch or less, about 1 centimeter or less) that is fixed therebetween. However, note that such configuration is not required. For example, the scanning unit 112 and the scanning unit 130 may be spaced apart from each other, during scanning, at the distance that may be adjustable therebetween. For example, as shown in FIGS. 29-32, the scanning unit 112 has a pair of projections (e.g., underneath its scanner head), projecting (e.g., cantilevered) from each lateral side, respectively extending through (i) the frame connected, attached, or monolithic with the box and (ii) a pair of openings on each respective sidewall of the pair of sidewalls of the frame of the housing 106, where the pair of openings are configured to allowed for a movement (e.g., sliding) along a vertical plane when the base portion 102 rests on a surface that is level or flat. For example, the pair of openings may be vertically oval or another suitable shape.

In view of FIGS. 1A to 1T and FIGS. 25-32, the apparatus 100 includes the housing 106 hosting the scanning unit 112 and the housing 128 hosting the scanning unit 130. In the closed configuration, the scanning unit 112 faces the scanning unit 130 (proximal to the compartment 114), as shown in FIG. 1A. In the open configuration, the scanning unit 112 avoids facing the scanning unit 130 (distal to the compartment 114), as shown in FIG. 1B. The apparatus 100 is switched between the closed configuration and the open configuration based on the housing 128 moving (e.g., sliding), relative to the housing 106, towards the compartment 114 or away from the compartment 114 via the pair of tracks 126, whether manually or automatically (e.g., by a motor or an actuator attached to the base portion 102 or the top portion 104), as shown in FIGS. 1A and 1B. In the open configuration, a technician deposits (e.g., put down, dropped) an agricultural product onto the scanning area 122. Then, the housing 128 is slid, whether manually or automatically (e.g., by a motor or an actuator attached to the base portion 102 or the top portion 104), toward the compartment 114, such that the apparatus 100 is in the closed configuration and the scanning unit 112 faces the scanning unit 130 (proximal to the compartment 114), as shown in FIG. 1A. During such sliding movement, the housing 128 is moved in an up-and-back motion from the closed configuration to the open configuration and a front-and-down motion from the open configuration to the closed configuration. As such, the agricultural product is positioned on the scanning area 122 between the scanner of the scanning unit 112 and the scanner of the scanning unit 130, to enable the scanner of the scanning unit 112 to scan the agricultural product from its underside and the scanner of the scanning unit 130 to scan the agricultural product from its topside, whether individually or on a per object basis when a quantity of agricultural products is deposited (e.g., a sample of seeds or pulses). Therefore, the scanner of the scanning unit 112 is positioned to face upwards to the scanning area 122 where the agricultural product is placed and the scanner of the scanning unit 130 is positioned to face downwards to the scanning area 122.

To place the agricultural product on the scanning area 122 for scanning, the housing 128 is slid or wheeled backward, which may be up-and-backward, relative to the housing 106 (or the scanning unit 112 is slid or wheeled forward relative to be positioned over the housing 106) via the pair of walls 110, to place the apparatus 100 in the open configuration. As explained above, such movement may occur via the pair of walls 110 having the pair of tracks 126 and the housing 128 or the scanning unit 130 being wheeled or slid to enable such movement on the pair of tracks 128, although the housing 128 may be pivotable or hinged relative to the housing 106 or the pair of walls 110, to open into the open configuration and close into the closed configuration, like a book or a clamshell, whether at its rear end or lateral side. Once the agricultural product is placed accordingly on the scanning area 122, the housing 128 is slid or wheeled back over to the housing 106 (or the scanning unit 112 is slid or wheeled backwards to be positioned over the housing 106). As explained above, such movement may occur via the pair of walls 110 having the set of tracks 126 and the housing 128 or the scanning unit 130 being slid or wheeled to enable such movement on the pair rails 126, although the housing 128 may be pivotable or hinged relative to the housing 106 or the pair of walls 110, to open into the open configuration and close into the closed configuration, like a book or a clamshell, whether at its rear end or lateral side. This positioning of the scanning unit 112 and the scanning unit 130 allows the apparatus 100 to capture at least two images (or at least two sets of images) depicting a top surface and a bottom surface of the agricultural product placed on the scanning area 122 relatively simultaneously (e.g., relatively in parallel) or in one action, capturing one image (or set of images) of the agricultural product from above (e.g., a top surface) and another image (or set of images) of the agricultural product from below (e.g., a bottom surface), while maintaining a uniform background for both images.

When imaging the agricultural product simultaneously or in one action, as noted above, various technological problems were identified. Specifically, the technological problem with capturing the images with both scanners (from the scanning unit 112 and the scanning unit 130) simultaneously or in one action is that, as the scanning area 122 is transparent, both scanners reflect each other resulting in a blown-out image. Also, even if one image is obtained after the other one (e.g., in series), the images do not come out uniformly, as many inner components of the opposite scanner would appear in the image. This state of being makes segmentation of objects in the images complicated, laborious, and time-consuming.

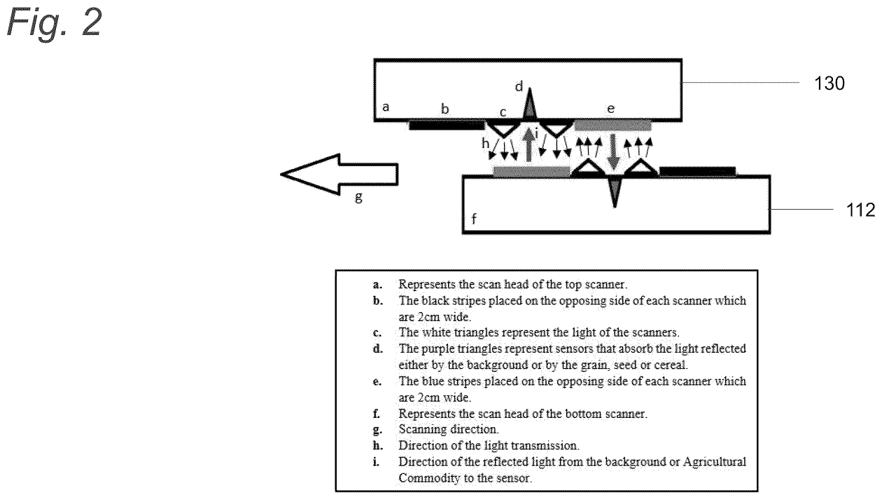

As shown in FIG. 2, these technological problems are solved in various ways. First, there is an adjustment of timing of the scanners, so that the scanner placed on the top (within the scanning unit 130) starts to move or scan before (e.g., inclusively less than about 2 seconds, inclusively less than about 1 second, inclusively less than about 0.5 seconds, inclusively less than about 0.1 second, inclusively less than about 900 milliseconds, inclusively less than about 800 milliseconds, inclusively less than about 700 milliseconds, inclusively less than about 650 milliseconds, inclusively less than about 625 milliseconds, inclusively less than about 605 milliseconds, inclusively less than about 600 milliseconds) the scanner placed on the bottom (within the scanning unit 112), or vice versa. For example, the scanner placed on the top (within the scanning unit 130) started to move or scan about 600 milliseconds before the scanner placed on the bottom (within the scanning unit 112). Although the adjustment of the timing of the scanners solved the technological problem, there may still be some reflection happening between the two scanners. In such situation, as shown in FIG. 2, a stripe (e.g., black color) is attached (e.g., adhered, hook-and-looped, magnetized) on the scanning unit 112 or the scanning unit 130, next to the light source (e.g., a lamp) of each respective scanner, but on opposing sides. For example, the stripe can be a rectangular (or another suitable shape) black stripe being 23 centimeters long and 2 centimeters wide (or other suitable dimensions) on the scanning unit 112 or the scanning unit 130, next to the light source of each respective scanner, but on opposing sides, although other colors, shapes, and sizes for the stripe are possible depending on use cases (e.g., scanner type, scanner size, scanner shape) when scanning the agricultural product. In that sense, as shown in FIG. 2, the stripe on the scanning unit 130 (leading) is placed in the bottom side thereof and the stripe on the scanning unit 112 is placed on the top side thereof. Both stripes may be as long as the respective scanning area is wide. As such, these stripes respectively absorb the reflection of the opposing scanner and respectively provide a background for the image (or set of images) captured by the opposing scanner.

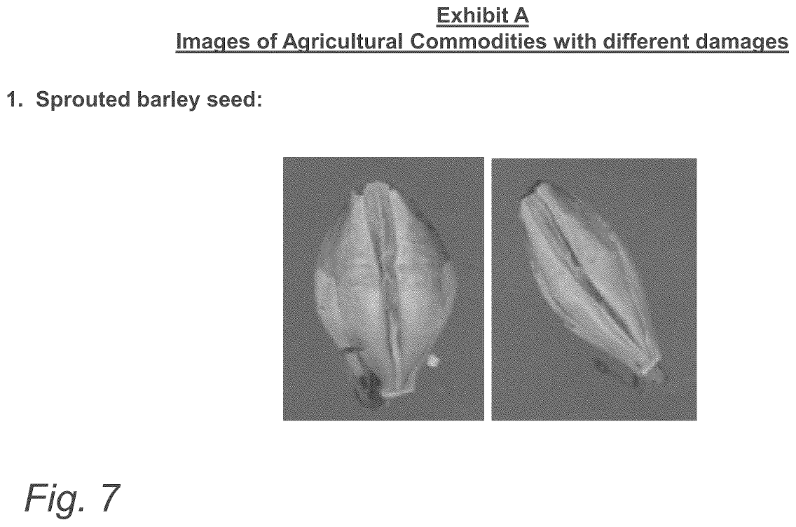

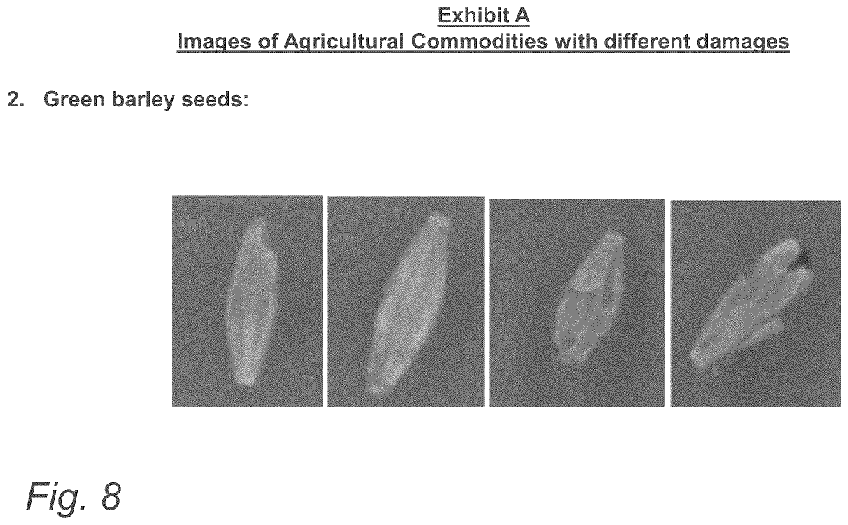

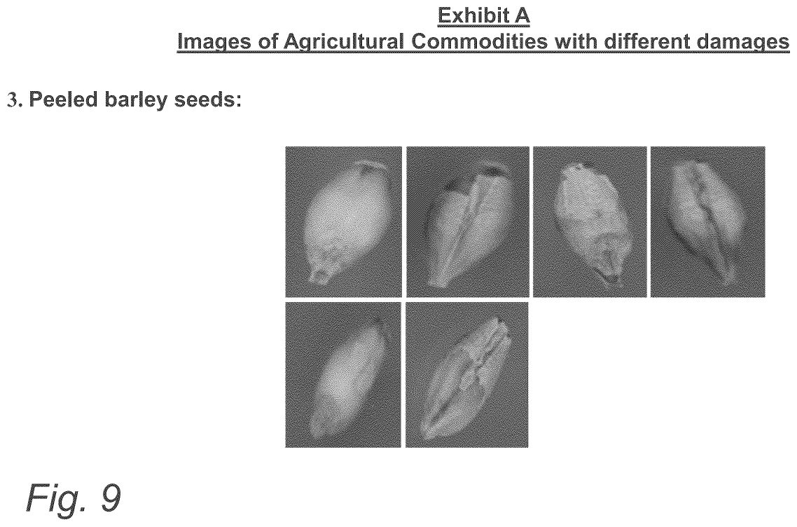

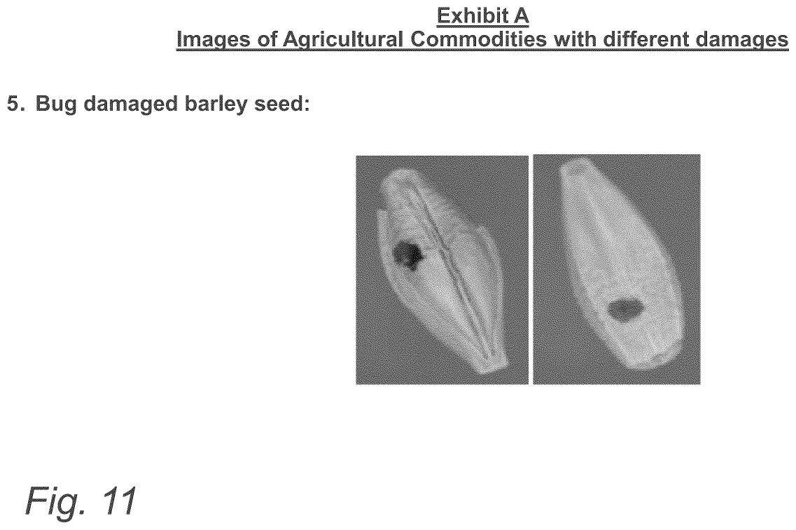

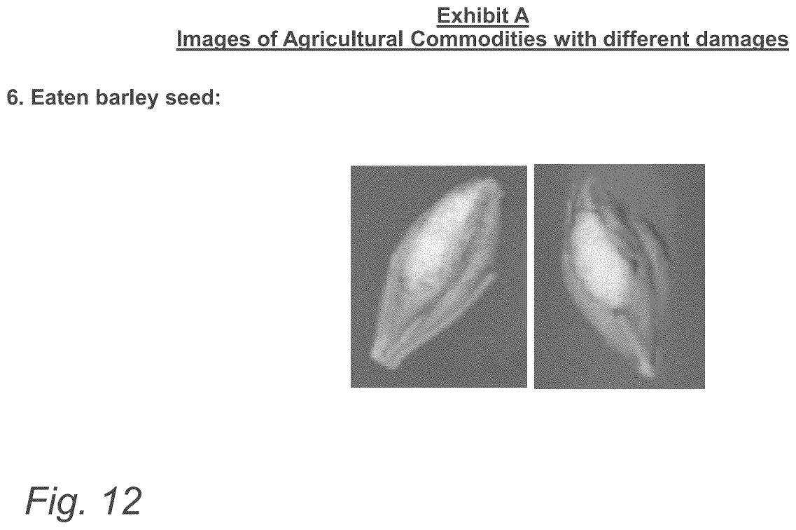

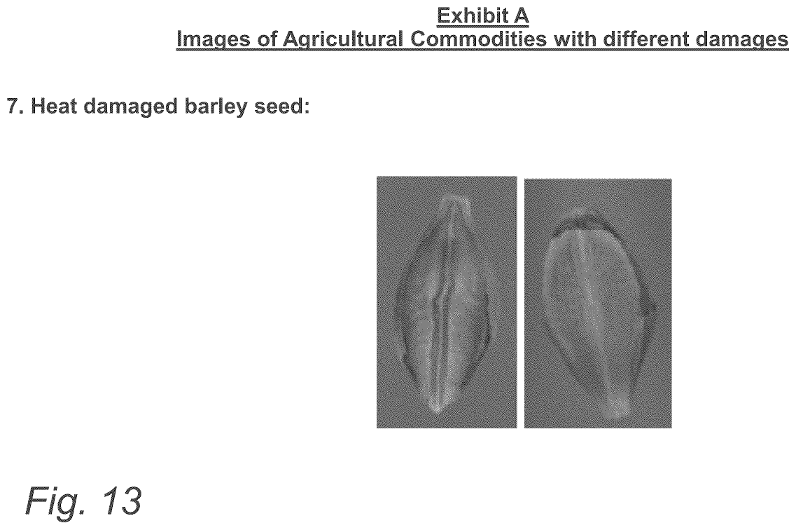

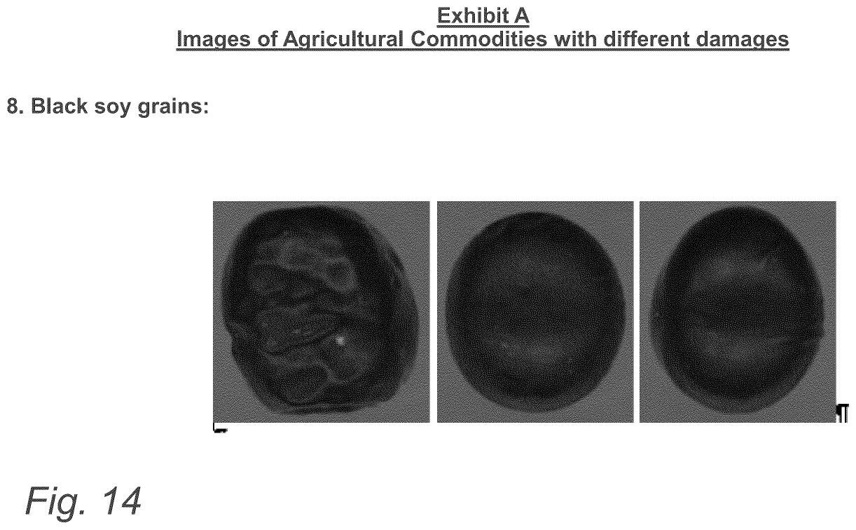

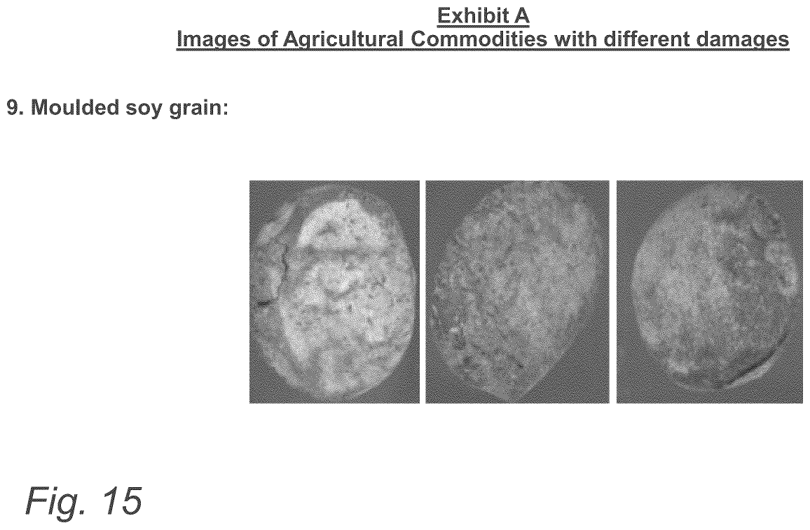

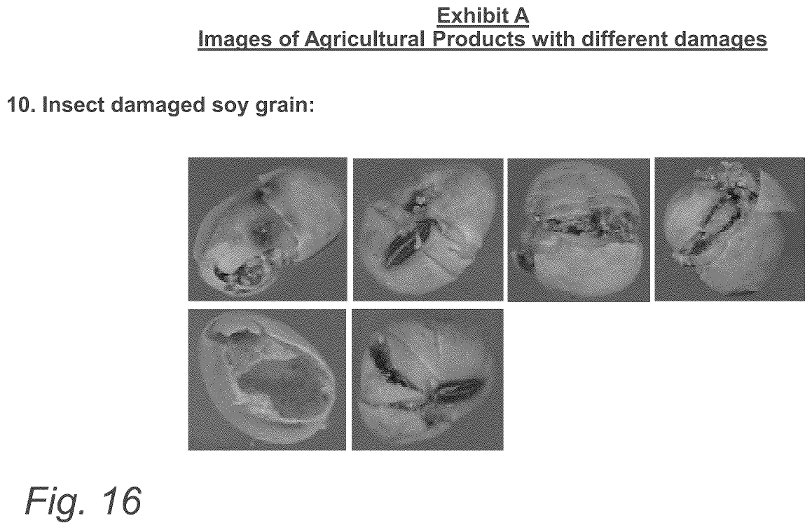

As shown in FIGS. 7-16, since some agricultural products (e.g., soy seeds) turn black when unhealthy, there are further technological difficulties for the scanners to respectively capture an adequate image (or set of images) of those unhealthy agricultural products. These technological difficulties propagate further and thereby may preclude or complicate identification (or segmentation) of those unhealthy agriculture products by various software algorithms, as further described below. Therefore, there may be another stripe with a color that is not found (or at least not easily found) in the agricultural industry. One example of such color is blue (e.g., inclusively at a wavelength between about 450 nanometers and about 495 nanometers). For example, when the strip is blue, then RGB values may inclusively be RGB max: [96 131 188], 2RGB min: [75 107 154], 3RGB mean: [84 120 173], which may be agnostic across various display equipment and may not change regardless of what type of display equipment is used. Another example of such color is blue or cyan (e.g., inclusively at a wavelength between about 450 nanometers and about 500 nanometers). Note that the blue or cyan stripes could have or be made with more than one color or pattern (e.g., hatching, polka dots), thus allowing the scanners to obtain images with different background colors or patterns to maximize the contrast of different agricultural products, by adjusting the timing of the scanners, as disclosed herein. Such coloring or patterning of the stripes enables the apparatus 100 to obtain two images (or two sets of images) simultaneously or in one action and also respectively provide a background for each image. Therefore, although the blue or cyan color for the agricultural commodities may work with some agricultural products, that color or pattern can be changed or another color or pattern may be added to the stripe in case another color or pattern may be desirable for a particular commodity/specialty/object. As such, when (a) the scanner placed on top (in the scanning unit 130) starts to move or scan before the scanner placed on the bottom (in the scanning unit 112), (b) when the strips are respectively placed on the scanning unit 112 and the scanning unit 130 next to the light source of each respective scanner, but on opposing sides (the stripe on the scanning unit 130 is placed on the bottom side and the stripe on to the scanning unit 112 is placed on the top side) and (c) the stripes are colored to have the color that is not found (or at least not easily found) in the agricultural industry, then the apparatus 100 has minimum reflections when imaging the agricultural product.

There may be some stripes that are black (or have one pattern) and some stripes that are blue (or have another pattern) or some stripes that are black and blue (or have two different patterns), whether on the scanning unit 112 or the scanning unit 130. For example, there may be a black stripe attached on the opposing side of each blue stripe, where the black stripe is sized or shaped identically to the blue stripe. In this way, if a black background is needed when imaging with the two scanners, then the software can command the apparatus 100 to change the order in which the scanners start and thus change the background color of the images. For example, the scanner of the scanning unit 130 may start to move or scan before the scanning unit 112, or vice versa. Likewise, note that the stripe, whether blue, black, or another suitable color (e.g., violet) or pattern selected from a range of colors or patterns in a visible spectrum color scale, is optional and that area may be painted or colored without the stripe or the stripes may be omitted.

Although the stripe (or that area being correspondingly colored, patterned, or painted) can be sized, shaped, and colored or patterned depending on use cases (e.g., scanner type, scanner size, scanner shape) when scanning the agricultural product, there are technological benefits when the stripe (or that area being correspondingly colored, patterned or painted) has a rectangular shape with a width (shorter side) that is inclusively less than about 5, 4, 3, 2.5, or 2.1 centimeters, especially when the stripe is colored blue (e.g., at a wavelength between 450 nanometers and 495 nanometers). For example, when the stripe is rectangular, has the width of about 2 centimeters, and is colored blue to face the opposing scanner, when the light of the scanner hits the agricultural product that is being scanned, the light gets reflected back and absorbed by a sensor placed next thereto, which is a light-sensing integrated circuit (e.g., a charged coupled device (CCD) or any similar or suitable sensor such as, but not limited to, CMOS. Since light-sensitive photosites arrayed along the CCD convert levels of brightness into electronic signals that are then processed into a digital image, as the scanner (top or bottom) moves or scans along, the sensor either sees the agricultural product or the background. As such, if the sensor fixes its attention to one exact line, i.e., the blue stripe could be imaged as a very thin line placed at the focus point of the sensor and be technologically problematic if the speed of that scanner (top or bottom) was not exact. For example, if any of the two scanners is delayed, or its speed suffers a slight variation, then the focus point of the sensor would change and so will the background color (increasing the chances of a blown-out image). Therefore, by attaching a 2 centimeter wide stripe (or that has the width inclusively less than about 5, 4, 3, 2.5, or 2.1 centimeters), that potential error is caught, assuring that the quality of the image will not be compromised by a slight variation of the speed of the scanners. Note that the blue stripes could be made with more than one color or pattern, thus allowing the scanners to obtain images with different background colors to maximize the contrast of different agricultural products, only by adjusting the timing of the scanners. As shown in FIG. 2, there are two scanners work seamlessly together with the blue (or black) stripes where the scanning area 122 (e.g., transparent glass, transparent plastic, or another suitable material) extends between the two scanners and supports the agricultural product, as explained above.

Although the stripes provide various technical advantages, as explained above, the stripes may be omitted. Additionally or alternatively, there may be electronic displays (e.g., liquid crystal displays, plasma displays, electrophoretic displays) positioned where the stripes are illustrated in FIG. 2, whether on the scanning unit 112 or the scanning unit 130. The electronic displays may be project outward, be flush, or project inward. The electronic displays may be controlled by the software to present whatever color (or any of its parameters or degrees) or pattern (or any of its parameters or degrees) as needed, as user-selected in the software based on what agricultural product is being scanned. For example, the color, the brightness, the refresh rate, and other suitable attributes or degrees may be user-selected. The displays may be sized and shaped to match the stripes or be different therefrom, whether in size or shape, whether larger or smaller. As such, the stripes may be analog (e.g., paper, plates, panels) or digital (e.g., electronic displays).

As the scanners may have production imperfections, some fiducial markers may be respectively attached (e.g., adhered, magnetized, hook-and-looped) thereto or to the scanning unit 112 or the scanning unit 130, which may include a white (or another suitable color) cross (or another suitable shape) with a black (or another suitable color) background made of acrylic (or another material) on some (e.g., 1, 2, 3, 4) or every corner of the scanning area 122 when the scanning area 122 is polygonal (e.g., rectangular, square). These fiducial markers may serve as fixed and expected marks on both images (or sets of images) that lay at the same physical position, thereby enabling the perspective correction (e.g., rectification) and the alignment to make both (top and bottom) scan images (or sets of images) sufficiently match. In addition to the aforementioned fiducial markers, there may be an extra triangular (or another suitable shape) fiducial to identify which one is the bottom image (or set of images) and which one is the top image (or set of images).

Note that as an alternative to using a pair of scanners, it is possible to obtain two images (or image sets) from above and from below simultaneously or in one action using a camera (photo or video). This embodiment may be less than optimal for some use cases, because using the camera: (i) may need a flash or a lightning system operably coupled thereto, thus making the apparatus 100 more complex (although this may be okay for some use cases); or (ii) to take an image of the same size of the scanning area 122 with a linear lens, the camera has to be placed at a larger distance, thus making the apparatus 100 bigger (although this may be okay for some use cases); or (iii) by using certain cameras, it would be difficult (but not impossible) in some situations to obtain two images simultaneously or in one action with the blue background or another color or pattern, as disclosed herein.

In view of above, the apparatus 100 solves various technological problems noted above. For example, (i) the apparatus 100 may enable imaging of the agricultural products (e.g., samples) from above and from below simultaneously or in one action in a small, compact, or portable form factor; (ii) the imaging may be made with a controlled background color with minimum or no reflections; (iii) the images (or sets of images) may be captured practically in the same time that it takes to obtain one image (or image set); or (iv) the images are obtained with optimum quality, allowing the software to make a proper analysis complying with (or even exceeding) some industry standards.

The apparatus 100 is operably coupled (e.g., electrically, signally, mechanically, communicably) to the software and may be controllable via the software or feed data into the software. The software may be running on the computer (e.g., an application program, a task-dedicated software engine that is startable, pausable, and stoppable) or the software can be cloud-based and accessed via a network connection (e.g., Wi-Fi, ethernet, cellular towers, satellite, 5G) via an application program running on the computer (e.g., a browser application program, a dedicated application program). The software may include an application program which may be operably integrated with or may communicate with the apparatus 100 to be used by the end user to perform different analyses, as disclosed herein. The application program may be used to command the apparatus 100 and to perform the required analyses. Although the application program is modular in functionality (e.g., a dedicated module for a user interface, a dedicated module for image processing), this configuration is not required and the application program may have another suitable configuration.

Note that the application program may be a dedicated application program for functionality disclosed herein or there may be other functionality together with functionality disclosed herein. Likewise, note that the software may be embodied in another form of logic other than the application program (e.g., an add-on, a browser extension).

The application program may enable a user interface programmed to enable the user to select: (i) the agricultural product identifier (e.g., a graphic, an icon, a text string, a user interface element) that will be subject to analysis (e.g., a soy bean); (ii) the type of analysis that the application program will perform (e.g., whether the soy bean is rotted); (iii) the specifications that the user wishes to use to measure the agricultural product under analysis (e.g., metric system); and (iv) the commercial identity of the agricultural product that will be analyzed (e.g., its origin identifier, its destiny identifier, the applicable quality norms, the year of harvest, the tracking number, the seller identifier, the owner identifier). Also, the user interface allows the user to start a new analysis, see the results of previous analyses (e.g., history of prior analyses) and see the images (or sets of images) obtained of the analyzed agricultural product, with the possibility of adding a grid (e.g., similar to a naval battleship game, a chessboard, an array, or another addressable data organization) onto the user interface displaying the imagery (that may have a function to remove it if desired) with columns identified with letters (or other suitable identifiers) and rows identified with numbers (or other suitable identifiers) to facilitate the search and comparison between agricultural products, e.g., the grains and/or seeds and/or objects classified by the software and the grains and/or seeds and/or objects placed on the scanning area 122. The letters and numbers of the grid may also be added on the top and left sides of the scanning area to facilitate the search of the agricultural products, e.g., the grains and/or seeds and/or objects placed on the scanning area 122 that were classified by the software.

Once the end user makes the desired selections via the user interface, the user places the agricultural product on the scanning area 122, closes the apparatus 100, as described above, and initializes the scanning from the user interface (e.g., selects and activates a user interface element) or the apparatus 100 itself (e.g., via a human-machine interface, a physical user interface, a graphical user interface, a touchscreen). In response, the apparatus 100 activates and obtains two images (or sets of images) of the agricultural product (e.g., in a JPEG, PNG, or another suitable image format), one from the above (the top scanner) and one from below (the bottom scanner), taking into account the timing between both scanners and the resolution to be used. Given that the images (or sets of images) may come out slightly misplaced or misaligned, the software automatically matches or aligns one image (or image set) on top of the other one by the use of the fiducials located next to the four corners of the scanning area 122 when the scanning area 122 is polygonal (e.g., rectangular) as a reference. Also, as explained above, the fiducials may enable the perspective correction.

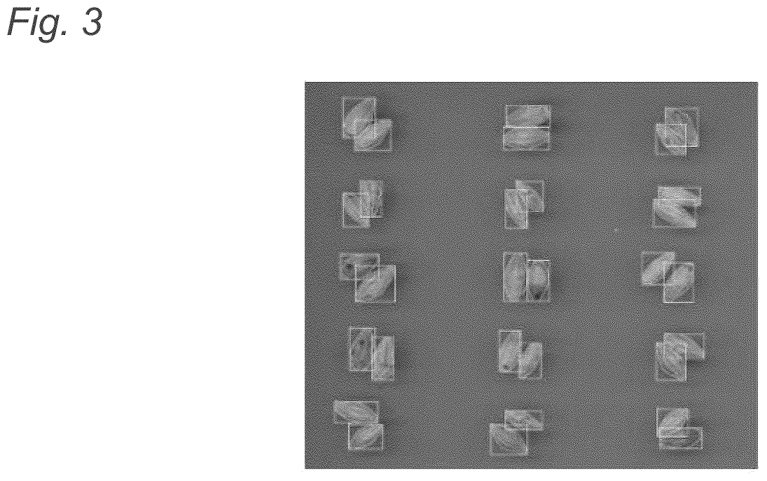

The application program has a segmentation logic (e.g., a segmentation software module) and the matched images (or image sets) enter into the segmentation logic where each object depicted in the two images (or two sets of images) is detected and segmented by the use of a segmentation algorithm. For example, the segmentation algorithm can include an artificial neural network (ANN) algorithm. For example, the ANN can include a You Only Look Once (YOLO) algorithm and a U-Net algorithm, as developed and pre-trained and working together, although other ANN algorithms may be used (e.g., CNN, RNN). The YOLO algorithm (or another suitable algorithm) detects each individual object of the image (or set of images) and encloses that individual object with a bounding box, as shown in FIG. 3.

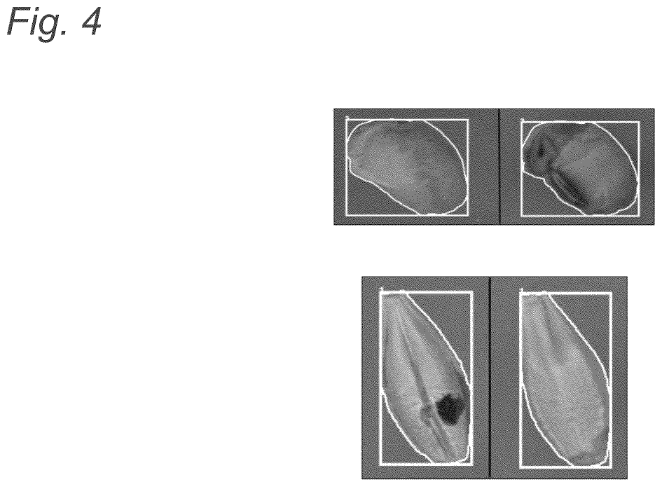

Once the images are detected by the ANN algorithm (e.g., YOLO algorithm), the ANN algorithm (e.g., U-Net algorithm) segments each object by drawing its contour, thus separating the object from the background and from other objects present in the bounding box. At this stage of the process, the application program only knows that the application program has to individualize and segment the objects in the image (or set of images), but the application program does not yet have the information to classify said object, so the application program individualizes every object on the images as blobs and pairs each blob with its counterpart in the other image, as shown in FIG. 4.

Prior to the segmentation logic being activated or segmenting, the software (e.g., the application program) may apply, if desired, a discard or ignore logic (e.g., a discarding or ignoring software module), which may be internal or external to the software, by which the software identifies different agricultural products, e.g., grains and/or seeds and/or objects in the image (or set of images), that should not be analyzed (e.g., discarded or ignored) by the classification module. The discard or ignore algorithms are previously trained to identify the objects included in the image that have to be discarded or ignored. For example, if the software is analyzing a sample to determine its varietal purity, the software may discard or ignore the images of the agricultural products, e.g., grains and/or seeds and/or objects, that do not contain the necessary morphological information regarding its variety. Some examples of images (or sets of images) of the agricultural products, e.g., grains and/or seeds and/or objects, that may be discarded or ignore are the damaged, green, broken, contaminations (e.g.: the analysis includes determining the varietal purity of a sample of a pulse or seed or soy and it is contaminated by a grain of corn; that grain of corn will be discarded or ignored), overlapped, pulses or seeds or soy beans or seeds are facing downwards, among others. Therefore, the discard or ignore algorithms facilitate the task of the classification algorithms. It is important to note that, in some embodiments, the discard or ignore algorithms are not applied to the analysis of physical quality determination (or omitted), because the classification algorithms are trained to classify every object in the image (or set of images).

The application program has a classification logic (e.g., a classification software module). As such, with the blobs being individualized and paired, the images enter into a classification ANN (e.g., a CNN, an RNN), which includes a supervised learning algorithm that is trained with supervised information (e.g., ground truth) to properly learn how to assign a label to each pair of blobs, thus classifying them. To that end, the classification ANN is trained by showing examples of images of different agricultural products (e.g., pulses, seeds, beans) with different labels allowing for subsequent application of such training to different unknown images obtained by the apparatus 100. The classification logic is programmed to classify one agricultural product (e.g., a member of a class of healthy agricultural products based on satisfying a threshold associated with the class versus not being the member of the class of healthy agricultural products based on not satisfying the threshold associated with the class of healthy agricultural products) taking into consideration both images (or sets of images) of that segmented agricultural product (e.g., both images collectively satisfying a threshold for a class). Therefore, if the classification logic identifies a healthy agricultural product in one image, but its counterpart in the other image is depicted to be bug damaged (or some other fault), then the classification logic is able to classify that agricultural product (via its identifier) as bug damaged (or some other fault), i.e., collectively not satisfying a threshold for a class (e.g., healthy agricultural product).

The application program enables physical weight estimation (e.g., kilograms, grams, milligrams) for the agricultural product being analyzed, whether individual agricultural product basis or per quantity of agricultural products. This estimation may occur once each blob is classified, the software is able to assign an estimated physical weight to every object present in the image (each agricultural product or foreign matter), through the application of an ensemble learning method for classification, regression and other tasks. For example, the ensemble learning method may include a random forests or random decision forests algorithm (RFA) for classification, regression and other tasks by constructing a multitude of decision trees at training time. The RFA (or another suitable ensemble or non-ensemble algorithm) may be trained and adjusted to be accurate in each of the labels the classification logic can return.

The application program may include a quality standard logic (e.g., a quality standards software module) that may be programmed to group the results of the classification and physical weight estimation into the different categories according to the quality standards of the country identifier or region identifier applied to the agricultural product under analysis. For example, if five grain depictions (ten segmented objects) of the sample have been assigned, during the classification module, with certain labels included in the damaged category, such as two bug-damaged grains, two green grains and one black grain, but the standard applied to that sample (e.g., settings set into the application program before scanning) is that only the bug-damaged grains and the black grains enter into the damaged category, then the quality standards logic would categorize the five grain depictions as three damaged grains and two green or undamaged grains. Note that the quality standards logic may be configured not to only categorize the agricultural according to the specifications of the country identifier or region identifier applied, but also categorize the agricultural product according to the requests made by the end users as needed (e.g., customized). Continuing with the example mentioned above, if according to the end user settings the green grains should be considered within the damaged category, then the quality standards logic would categorize the sample as having five damaged grains.

After the application program segmented, classified, estimated physical weight of the agricultural product and categorized the agricultural product according to the standards applicable (or according to the custom request), the application program enters into the results section of the user interface where the results of the analysis are collected and grouped into larger categories taking into consideration the selections made by the end user at the beginning of the analysis and displays them in the screen (e.g., electronic display, touchscreen) of the computing terminal (e.g., a desktop computer, a laptop computer, a tablet computer, a mobile phone, a wearable computer, a vehicular computer, a kiosk computer) connected to the apparatus 100, whether wired, wireless, or waveguide. The results displayed include perceived quality identifier of the agricultural product, the ratio or percentage of varietal purity, the ratio or percentage of waste, the ratio or percentage of broken agricultural products, the ratio or percentage of damaged agricultural products, the percentage of foreign matter (e.g., weeds, insects), the ratio or percentage of oleic, peeled and sprouted agricultural products, or others. The data of the results may be converted into a data file (e.g., a portable document format (PDF) file, a productivity suite file, a spreadsheet, an image) and saved or downloaded by the user and for future consults. For example, the data may be presented in a grid, one page per agricultural product, an auto-generated summary, or another suitable content, whether alphanumeric or graphic.

The application program may include a scan logic (e.g., a scan software module) programmed to coordinate the digitalization of the different agricultural products to train the different ANNs that may be included in the software. For example, the YOLO algorithm and the U-Net algorithm included in the segmentation logic, the classification networks included in the classification logic, and the RFA included in the physical weight estimation logic. The training of the different ANNs starts with the digitalization of different agricultural products. The digitalization is coordinated by the scan logic, which includes some software that controls the apparatus 100, allows the entering of metadata associated with the characteristics of the agricultural product (and identifier thereof) and commands the apparatus 100 to digitize the agricultural product. The metadata of the agricultural product may include a variety identifier, an origin identifier, applicable norm identifiers, physical characteristic identifiers, state of healthiness, whether the agricultural product is broken or not (binary or Boolean), year of harvest, physical weight or other suitable metadata. Once the metadata is entered accordingly, the scan logic commands the scanners of the apparatus 100 to scan the agricultural product, thus obtaining two images (or two sets of images): one from above (the top scanner) and one from below (the bottom scanner). The scan logic populates a database (e.g., a flat database, a relational database, a NoSQL database, an object database, a graph database, an in-memory database) within the application program or related to the application with many images to have them ready to train the ANN algorithms. Once the database is populated, the information contained therein can be accessed by the use of queries.

The segmentation logic may include the ANN algorithm, which may include two sub-ANN algorithms, which may be operating in concert where one algorithm detects the objects and the other algorithm segments the objects. For example, these two algorithms can include: (i) the YOLO algorithm (or another suitable algorithm) that detects the agricultural product, as well as foreign matter, in the images (or sets of images) and encloses each detected agricultural product (or object) in a respective bounding box; and (ii) the U-Net algorithm (or another suitable algorithm) which segments each detected agricultural product (or object) in the image (or set of images) by drawing its contour, thus individualizing it. The two sub-ANN algorithms (e.g., YOLO algorithm and the U-Net algorithm) are supervised algorithms, which are trained with supervised information (e.g., ground truth) to properly learn how to detect and segment agricultural products, or foreign matter, in an image (or set of images). To that end, the two sub-ANN algorithms are shown examples of images (or sets of images) of different the two sub-ANN algorithms that are properly detected and segmented allowing those algorithms to apply such learning later on to different unknown images (or sets of images) obtained by the apparatus 100.

To generate the ground truth to train the algorithms, there may be various ways of doing so. For example, one way is to use a tool Computer Vision Annotation Tool (CVAT) that allows to manually draw the contours of the grouped objects in an image (or set of images) depicted on the computing terminal, i.e., by the use of the human eye to manually draw the contour of the different objects that are grouped in the image (or set of images), thus limiting the error of the algorithm to the error of the human eye, which, for drawing the contour of an object in an image (or set of images), is very low considering its simplicity (and time-consuming). The images (or sets of images) that have been validated/supervised by the human eye may serve as ground truth for the automated learning of the two sub-ANN algorithms (e.g., YOLO and U-Net). Also, to improve the accuracy of the two sub-ANN algorithms, there may images (or sets of images) with different difficulties/complexity that may be used, i.e., to imitate the way in which future users will place the agricultural product on the apparatus 100. Under that scenario, the agricultural products (and foreign matter such as straws) are grouped in numbers of two, three, four, five, and so on.

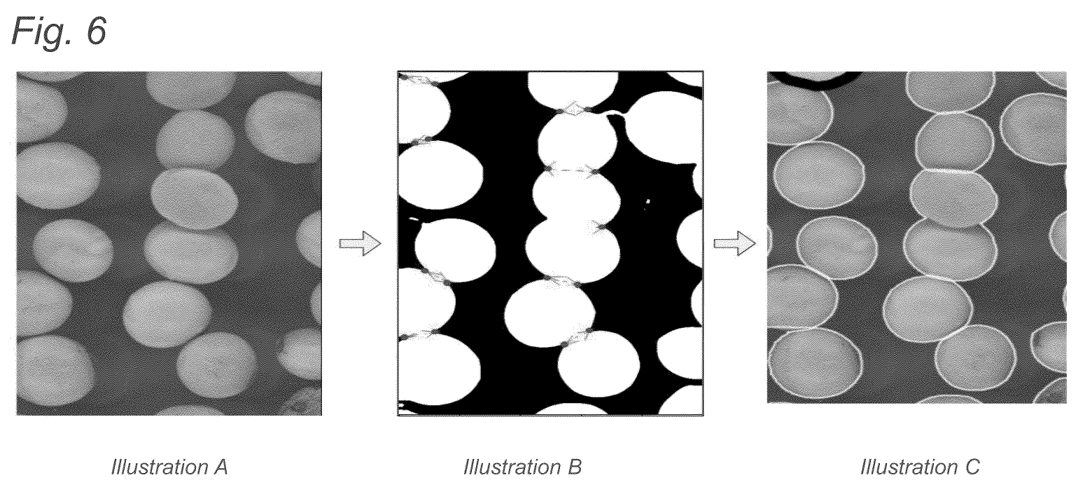

The images (or sets of images) are annotated by drawing the contours of the objects (e.g., with the CVAT framework). To speed up this process, each such image (or set of images) may be run through an automatic segmentation tool which includes an algorithm that draws the contours of the objects in an image (or set of images) in an approximated and automatic manner. This algorithm has the same purpose of the segmentation logic, which is to obtain the contours of each object in the image, but works without using or minimally using artificial intelligence (AI). Sometimes, in some use cases, the segmentation logic may fail to detect and split objects in situations where objects are overlapped or grouped by many. These errors are what human annotators rectify with the use of the CVAT framework (or another suitable logic) after running the segmentation logic. FIG. 6 shows an example of the segmentation logic at different stages.

The workflow of the segmentation logic may involve the algorithm analyzing the image (or set of images) to find the pixels that belong to the background of the image (or set of images), which are in a range of blue colors or other suitable colors or patterns. In some embodiments, it has to be a range because the algorithm has to consider the reflections of the objects in the scanning area 122 and any shadows produced by the objects over the blue stripes during the scanning process (Illustration A). Then, a “mask” (Illustration B) is created, where white areas correspond to the objects that will be analyzed, and the black areas correspond to the background that will be discarded or ignored by the algorithm. Then, morphological operations are applied to the mask to minimize noise and spurious detections of background and objects, and to soften all contours, i.e., the morphological operations are a way to clean and improve the quality of the mask. Then, the mask is searched for strong wedges, which may be potential points for splitting objects (which are the red dots in Illustration B). Then, search for pairs of wedges laying on the opposite side of the blob that point to each other is performed. In order to determine if a wedge belongs to its counterpart on the opposite side of the blob, the algorithm takes into consideration the angle and the distance from each wedge. Then, a line is traced from the vertex of the wedge to the vertex of its counterpart on the opposite side of the blob (if any), thus splitting the blob into smaller blobs. Once the segmentation logic finishes the analysis, the majority of the objects in the image should be individualized (Illustration C). As this segmentation logic works automatically, providing pre-drawn contours for all objects in the images (or sets of images), the human annotating task, by the use of the CVAT framework (or another suitable framework), is performed much faster than if that task was done manually from scratch.

The application program may include the classification logic that employs a convolutional neural network (CNN), which is an ANN that is used for the analysis of images and that has a specialization for being able to pick out or detect patterns and make sense of them, although other neural networks (e.g., RNN) may be used. For example, there may be optical markers that are certain morphological data points that the algorithms of Al may capture, learn, and identify during their training phases at least for recognizing at least some physical characteristics that distinguish different types of damages or varieties of agricultural commodities (e.g., they are morphological reference points). In this context, when provided with sufficient training data (with enough variability and certainty of purity), at least some algorithms acquire the ability to determine the physical quality or varietal purity of agricultural commodities by using the collected optical markers as a reference during their learning process. For example, shape, size, pattern, color, or brightness identified may be optical markers, although other suitable types of optical markers are possible. The CNN architecture is adapted to the analysis of images (or sets of images) of different agricultural products, to detect all of their characteristics and be able to differentiate them from each other. The architecture of the CNN comprises two stages. The first stage includes extraction of the characteristics of the images (or sets of images). This section comprises multiple convolution layers. Each layer has a defined amount of filters that extract the characteristics of the images (or sets of images) to detect patterns, such as size, shape, physical characteristics, diseases, among others. The second stage includes classification where this section comprises multiple classification layers that have a defined amount of activation units. Both stages of the CNN are optimized during the training, involving an iterative process of forward and backward propagation through the CNN. Since the CNN is a supervised learning algorithm (although non-supervised may be used in certain use cases), the ground truth is used to show to the network so that the CNN can learn and generalize properly. The images (or sets of images) taken during the scan logic are used for these purposes. For example, in the determination of the varietal purity of barley, if the selected images belong to the varieties Andreia, Shakira and Overture, then the training will be focused in identifying the required coefficients to identify them. In other words, the CNN learns the characteristics that differentiate each variety. Another example could be given with the damages suffered by soy grains. In this case, for the identification of said damages, various images (or sets of images) of different damages are used to allow the CNN to learn to identify the difference between each damage (the CNN learns to identify the characteristics of each damage).

As explained above, in addition to the segmentation and classification of different agricultural products, the application program is also trained to estimate their physical weight by the physical weight estimation logic. The algorithm used for said task is the RFA (although other ensemble or non-ensemble algorithms may be used). The RFA performs through a supervised learning technique and includes a process that combines multiple classifiers to solve a complex problem and to improve the performance of a model. The RFA may be a classifier that contains a number of decision trees on various subsets of the given dataset and takes the average to improve the predictive accuracy of that dataset. Instead of relying on one decision tree, the random forest algorithm takes the predictions of all trees and based on the majority votes, the RFA predicts the final output. The essence of this algorithm is that many weak estimators (multiple Decision Trees) can make a robust, strong unique estimator (Random Forest). The greater the number of trees in the forest, the higher the accuracy. As noted above, most or every image (or set of images) of agricultural products, alongside with its statistical weights, is stored in the database (e.g., relational, NoSQL, in-memory, multi-model, graphical) which serves as the ground truth used for the training. To improve the accuracy of the physical weight prediction of a sample, there may be a great variability on the examples to have good performance at the inferring time. Under said scenario, each image (or set of images) of an individual agricultural product is statistically weighed and grouped agricultural product according to their weight, and then scan images where every agricultural commodity is of the same statistical weight. With this method, at inference time, it is possible to accurately predict the physical weight of a new (never seen) image of an agricultural product based on features, such as position on the scan (e.g., x and y coordinates), classification output, dimensions, scan resolution, aspect ratio, or others. Once the application program segmented and classified an individual agricultural product, the trained algorithm assigns the physical weight of the classified objects in the image (or set of images). Most or all the individual weights of the same category are summed up, formatted and informed upon the respective applicable specification.

Therefore, based on above, whether used with the apparatus 100 or not, the software logic enables (i) matching or aligning the bottom image and the top image with each other, (ii) perform a perspective correction on the bottom image or the top image, (iii) segment a first object in the bottom image and a second object in the top image after the perspective correction is performed, (iv) form a composite image depicting the first object and the second object, (v) input the composite image into a classification algorithm such that the classification algorithm outputs a label for the composite image, (vi) input the composite image and the label into a physical weight estimation algorithm such that the physical weight estimation algorithm outputs a physical weight estimate, (vii) formulate a ratio estimate, a percentage estimate, or a proportion estimate for the agricultural product based on the label and the physical weight estimate. For example, the ratio estimate, the percentage estimate, or the proportion estimate may indicate whether the agricultural product or how much of the agricultural product is sound or satisfactory, as explained above, versus not sound or not satisfactory, as explained above. For example, when the user interface presents the results (e.g., in a grid), the results may include the ratio estimate, the percentage estimate, or the proportion estimate.

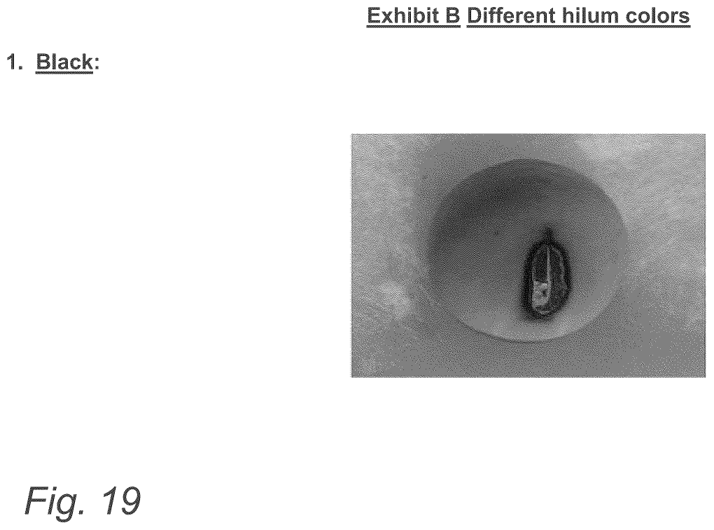

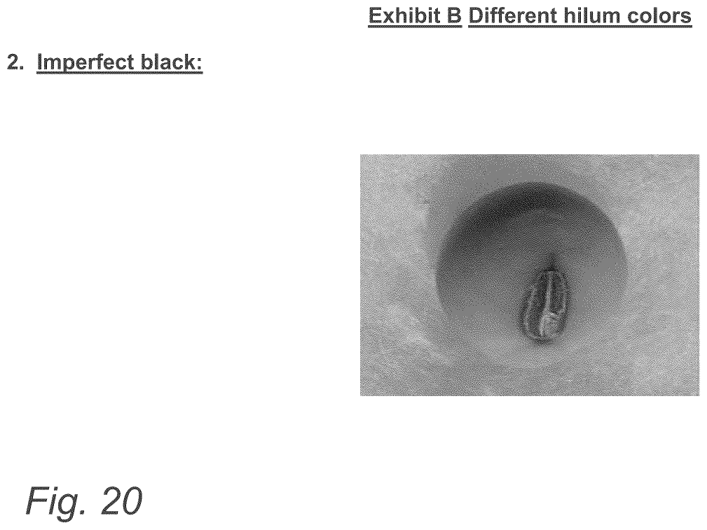

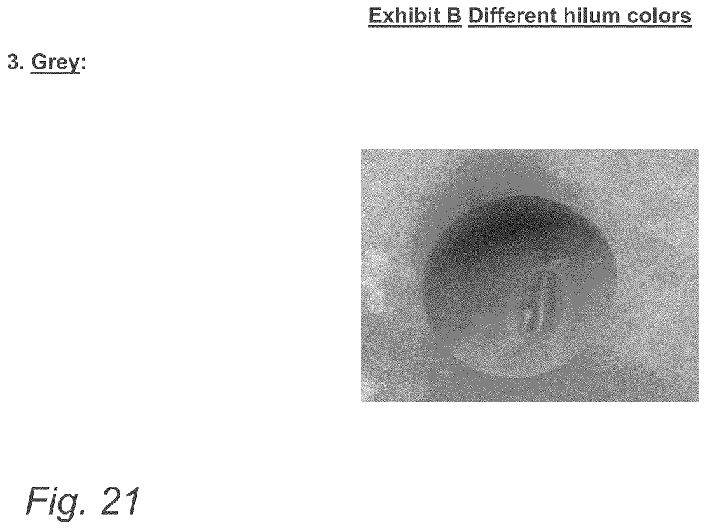

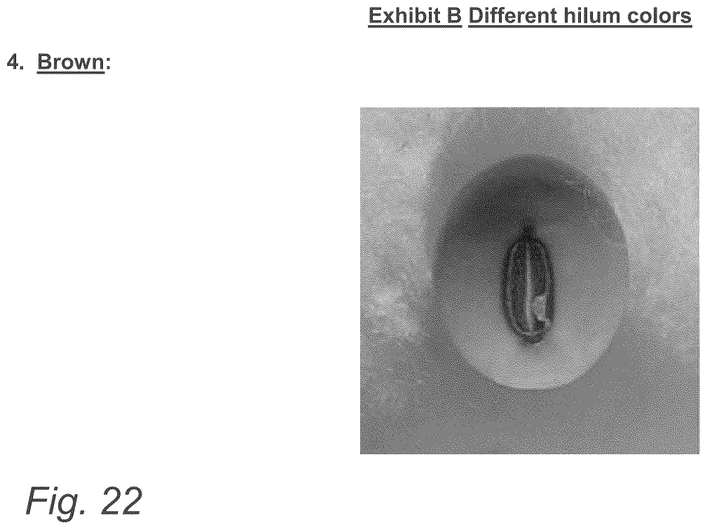

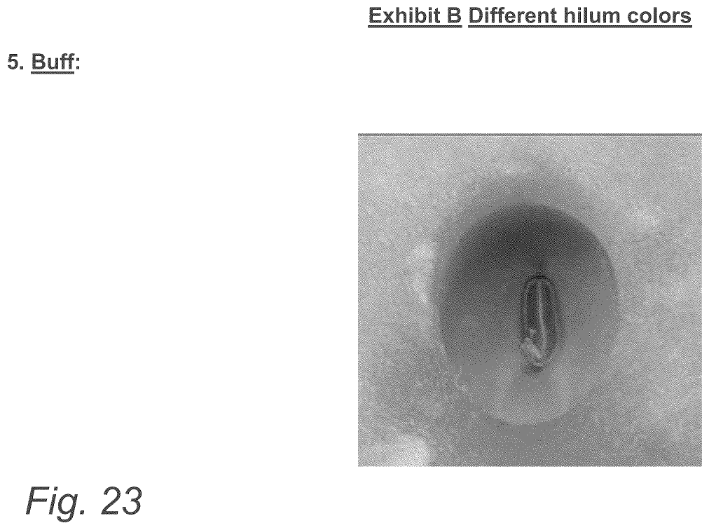

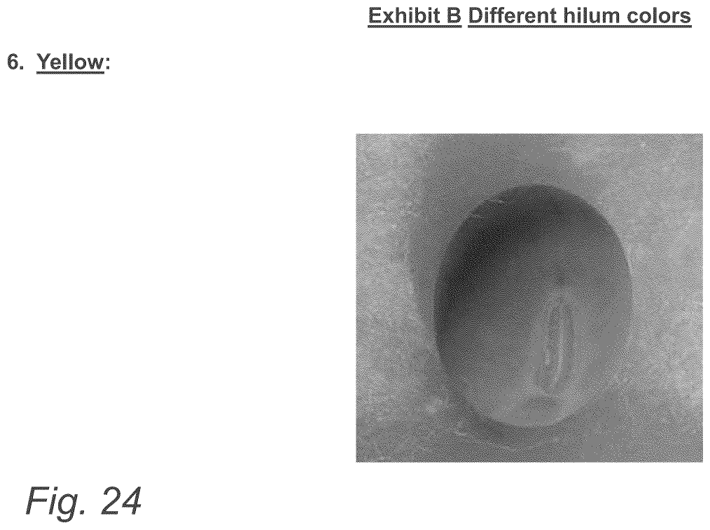

In some embodiments, the application program and the software, as disclosed herein, may be used to improve a breeding process of new soy (or other bean, legume, or pulse) varieties by determining their hilum color. In particular, a characteristic of soy varieties is that most or every variety has a certain hilum color. There are six different soy hilum colors: black, imperfect black, brown, buff, yellow and gray, as shown in FIGS. 19-24. During the breeding process of soy varieties, one of the indicators that show that a variety has been properly stabilized is the uniformity of the hilum color. Although soy varieties may have different hilum colors, in order to be commercialized, the hilum colors have to be stable, i.e., a representative sample of the batch should have the soy seeds with the same hilum color as the hilum color is a strong indicator that the variety is stable, but not the only indicator. Breeding processes of new soy varieties take from 7 to 10 years and are costly to develop. Throughout the breeding process, the hilum color of the seeds is analyzed on multiple occasions. Today, this process is performed manually. Various soy seed specialists separate a sample of many seeds (e.g., tens, hundreds, thousands) and analyze each individual seed with the naked eye to verify that every seed has the same hilum color. If a variety does not present a uniform hilum color at a certain part of the process, then that variety is discarded or ignored. There are several technological problematics associated with this process: (i) subjectiveness in the determination of the hilum color; (ii) human errors; (iii) it takes 15 to 20 minutes to analyze each sample; (iv) every sample has to be analyzed by a specialist; (v) labor shortages or union strikes; and (vi) many seed companies have breeding networks distributed throughout many locations of the country, but the analysis are carried out in one or a few labs of the seed company, meaning that the experimental samples of many locations have to be shipped to the lab/s to be analyzed, thus increasing the costs and the time of the process.

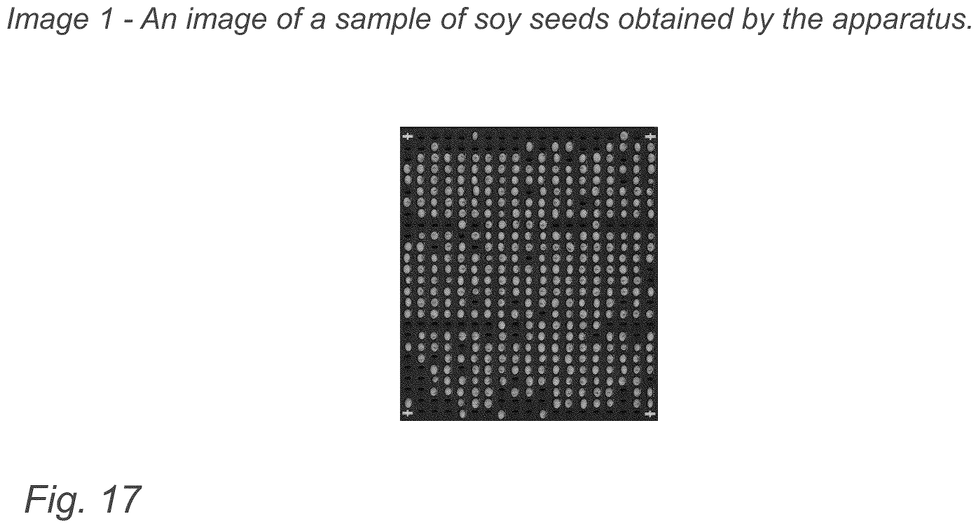

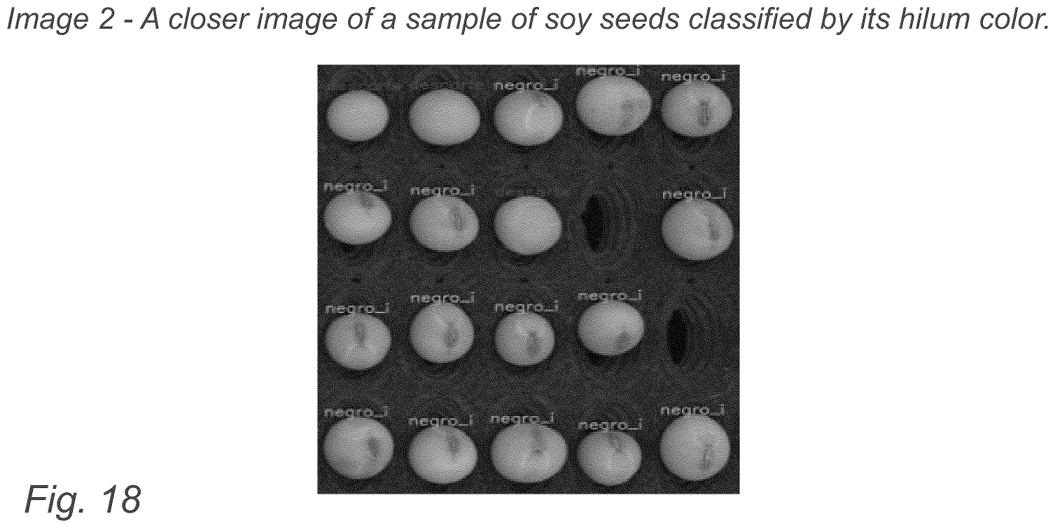

The apparatus 100 and the software solve these technological problems in various ways. For example, as shown in FIGS. 17 and 18, the apparatus 100 may obtain an image (or set of images) of the agricultural product and analyzes the image (or set of images) with the trained ANNs to determine whether there is uniformity or not in the hilum color of the variety. As shown in FIGS. 17 and 18, the apparatus 100 obtained only one image (or set of images) from above, using the black grid as the background of the image (or set of images). For that process, the ANNs are trained to identify most or every hilum color, thus simplifying the process. Therefore, the apparatus 100 and the software improve the breeding process by: (i) providing objectiveness in the determination of the hilum color; (ii) reducing the time and costs of analysis, (iii) improving the logistics; (iv) minimizing manual work; and (v) unifying the criteria to determine the hilum color of an individual grain, among others. As shown in FIG. 18, prior to determining the hilum color of most or every individual soy seed, the software discards or ignores the soy seeds of which the software cannot see the hilum. The algorithms that determine the hilum color of soy seed are trained as disclosed herein. Therefore, the apparatus 100 and the software improves the efficiency of the breeding process of soy varieties.

As explained above, in some embodiments, the apparatus 100 may be configured, such that the scanning unit 130 and the scanning unit 112 are movable (e.g., slide, wheeled, hinged) relative to each other or the housing 106. For example, there may be one, two, or three possible movements: (i) the movement (e.g., slide, wheeled, hinged) of the scanning unit 130 (e.g., along a horizontal plane) to place the apparatus 100 into the open configuration or the closed configuration relative to the scanning unit 112; (ii) the movement (e.g., slide, wheeled, hinged) of the scanning unit 112 (e.g., along a vertical plane) relative to the scanning unit 130, to adjust the distance between the scanning unit 130 and the scanning unit 112, to enable placement of different agricultural products (e.g., barley vs chickpeas); and (iii) the movement (e.g., slide, wheeled, hinged) of the box (e.g., along a horizontal plane) out of and into the compartment 114 relative to the housing 106, each as described above.

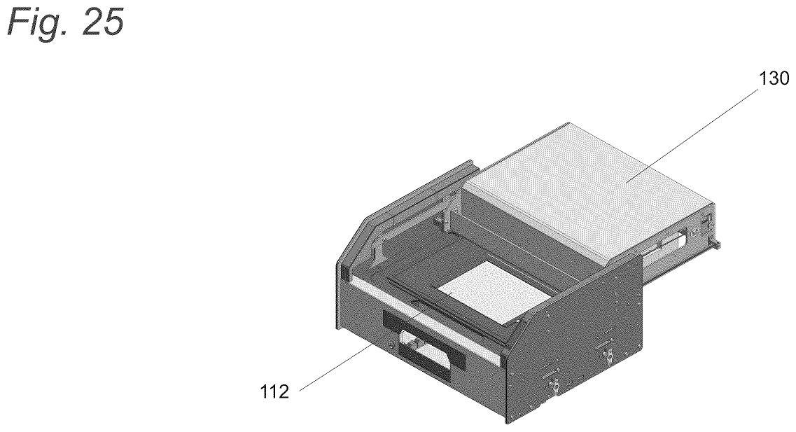

As shown in FIGS. 25-32, the scanning unit 130 is movable (e.g., slide, wheeled, hinged) to place the apparatus 100 in the open configuration or the closed configuration. This movement includes: (i) sliding the scanning unit 130 backwards, which may be up-and-backwards, relative to the housing 106, along a horizontal plane, to place the apparatus 100 into the open configuration and enable placement (e.g., deposition) of the agricultural product that will be subject to analysis; and (ii) pulling the scanning unit 130 forwards (e.g., retracting), which may be forward-and-down, relative to the housing 106 along a horizontal plane, to place the apparatus 100 into the closed configuration.

The scanning unit 112 is movable (e.g., slide, wheeled, hinged) relative to the housing 106 or the scanning unit 130 along a vertical plane, to adjust the distance between the two respective scanners, whether manually or automatically (e.g., a motor, an actuator). Since agricultural products have different sizes, the vertical distance between the scanning unit 130 and the scanning unit 112 should vary, because the scanning unit 130 should be as close to the agricultural product as possible. Smaller agricultural commodities, such as wheat or barley seeds, allow the scanning unit 130 to be closer to the object and as the scanning unit 130 gets closer to the object, the sharpness of the image increases. As the image gets sharper, the algorithms obtain more visual information to identify more features to ultimately learn the characteristics that differentiate damages or varieties. For example, the vertical distance between the scanning unit 130 and the scanning unit 112 can be (i) inclusively less than about 20 millimeters, about 15 millimeters, about 10 millimeters, about 9 millimeters, or about 8 millimeters for use with wheat and barley seeds (e.g., inclusively about 7 millimeters), (ii) inclusively between about 9 millimeters and about 20millimeters (e.g., inclusively about 10 millimeters) for use with soy seeds, or (iii) inclusively between about 9 millimeters and about 20 millimeters (e.g., inclusively about 13 millimeters) for use with chickpeas. Therefore, the apparatus 100 includes a mechanical feature (e.g., a frame feature, a frame opening, a vertically oval frame opening, a frame opening that is inclined, a spring, a motor, an actuator) that allows the adjustment of the vertical height of the scanning unit 112, within the base portion 102, relative to the scanning unit 130, thus modifying the vertical distance between the scanning unit 112 and the scanning unit 130. For example, the software may be programmed to adjust the vertical distance by software based on various parameters (e.g., a user input indicating a type of agricultural product, a resolution parameter, a desired height, a desired height preset, a default height). For example, the scanning unit 130 may be movable (e.g., slide, wheeled, hinged) along a vertical plane to adjust the vertical distance between the scanning unit 130 and the scanning unit 112, whether manually or automatically (e.g., a motor, an actuator). As such, the apparatus 100 may include a mover (e.g., a motor, an actuator) controlled by the software to adjust the vertical distance between the scanning unit 112 and scanning unit 130.

The box is movable (e.g., slide, wheeled, hinged) out of the compartment 114 and into the compartment 114 along a horizontal plane. This movement enables retrieval of the agricultural product from the box, after the agricultural product is scanned and moved into the gap 124 to be guided by the hollow shaft into the box, and then repositioning the box for receiving the next agricultural product after its respective scanning. The movement of the box can include sliding the box outwards relative to the housing 106 until the box is withdrawn from the compartment 114 or entirely detached from the apparatus 100, although partial detachment or non-detachment is possible as well. In order to place the box back into the compartment 114 or position the box to its default state, the box may be slid back into the same space from which the box was retrieved, i.e., the compartment 114.

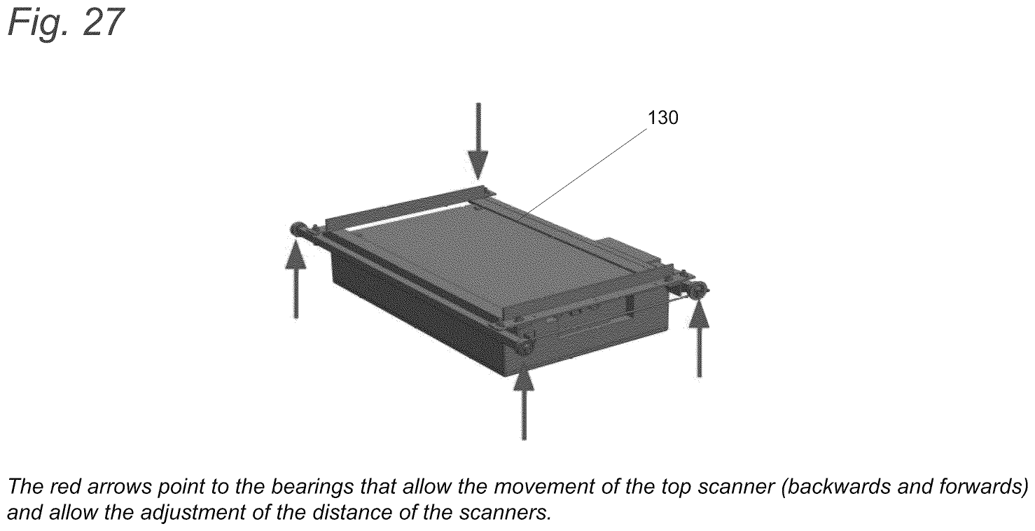

As shown in FIGS. 27-29, the scanning unit 130 has a rectilinear movement system, which enables scanning unit 130 to move along a horizontal plane. For ease of reference, this system is depicted in FIG. 27 in blue and violet. For example, the scanning unit 130 is slidable backwards and forwards, along a horizontal plane when the housing 106 is upright. The violet parts allow the sliding movement of the scanning unit 130 (backwards and forwards relative to the housing 106) by the use of the projections (e.g., bars) included in the external bottom side of the violet parts. The blue parts allow an incline (e.g., inclusively about 2 degrees, about degrees, about 10 degrees) of the scanning unit 130 as the scanning unit 130 is slid backwards relative to the housing 106, to prevent the scanning unit 130 from colliding with the placed agricultural product. For example, the scanning unit 130 may travel along the pair of tracks 126, which may be hockey stick shaped, to allow for such incline via a bent or curve toward the housing 106. For example, the incline may be generated by the bearings (e.g., four bearings, two bearings, eight bearings) placed at the sides of the blue part which move along the guide (yellow part shown in FIG. 4 below) which remains stationary.

As shown in FIG. 30, the scanning unit 112 is movable along a vertical plane relative to the housing 106 or the scanning unit 130 to adjust the distance between the scanning unit 112 and the scanning unit 130, while also enabling the box attached, connected, or monolithic with the frame to move out of the compartment 114 or into the compartment 114. The movement of the scanning unit 112 to adjust the distance between the scanning unit 112 and the scanning unit 130 is vertical. This movement is enabled by two mechanical groups, which are illustrated by green and red parts. As shown in FIG. 30, the green part includes the scanning unit 112, which has four bearings that jut out from the four endings of both sides of the scanning unit 112, although other amounts of bearings are possible (e.g., two, eight). As shown in FIG. 30, the box attached, connected, or monolithic with the frame is depicted to be out of the compartment 114 due to a gap present between the scanning unit 112 and the frontal member of the frame from which the box extends. In contrast, in FIG. 31, the box attached, connected, or monolithic with the frame is depicted to be inside the compartment 114, due to the gap being absent between the scanning unit 112 and the frontal member of the frame from which the box extends. Further, the movement may be generated jointly by the staggered guides placed in the two ends of the red lateral bars and the green bearings attached to the sides of the scanning unit 112. The red lateral bar moves along a horizontal plane to enable the box to move out and into the compartment 114, while the green bearings allow the scanner to move upwards and downwards along a vertical plane.

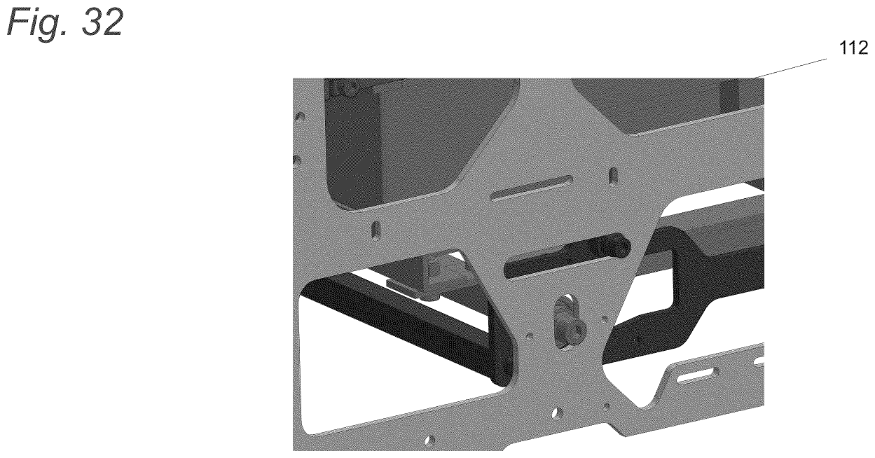

As shown in FIG. 32, the red lateral bar, and the movement of the scanning unit 112, is guided by the lateral part of the chassis of the apparatus 100 (which remains stationary) by the use of the bearings attached to the red lateral bars and to the bottom scanner. Note how the green bar (or projection) engaging the frame of the housing 106 enables the motion of the scanning unit 112 along a vertical plane to adjust the vertical distance between the scanning unit 112 and the scanning unit 130. Further, the box (when connected to its frame) is movable relative to the housing 106 body. The box may be detached from the apparatus 100 by pulling away from the housing 106. The yellow part of the apparatus 100 (which remains stationary) may have horizontal lines on the internal side where the box is placed to guide its movement outwards and inwards relative to the housing 106.

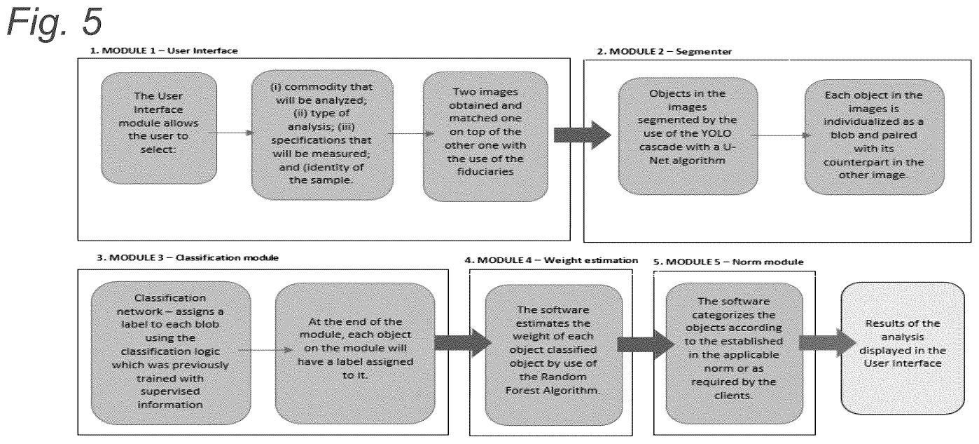

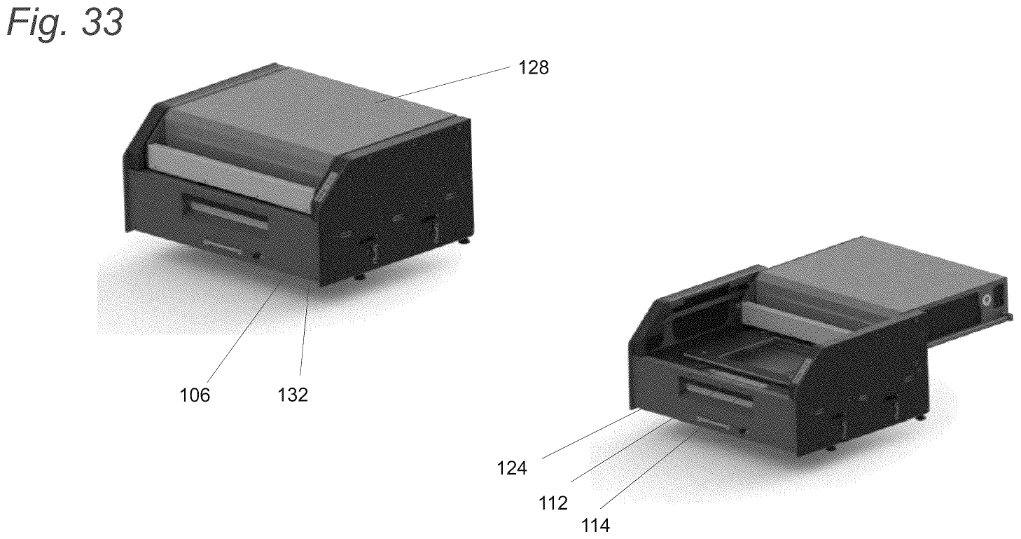

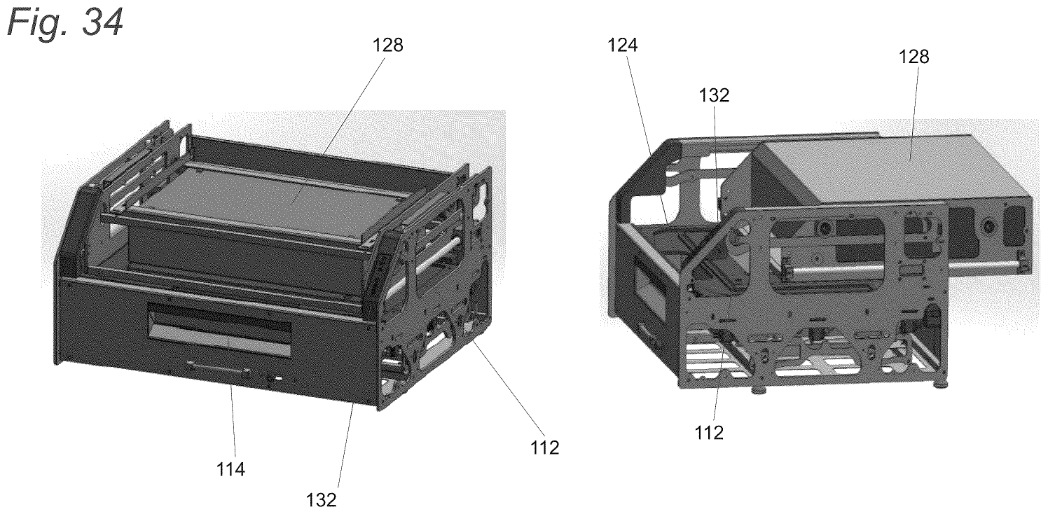

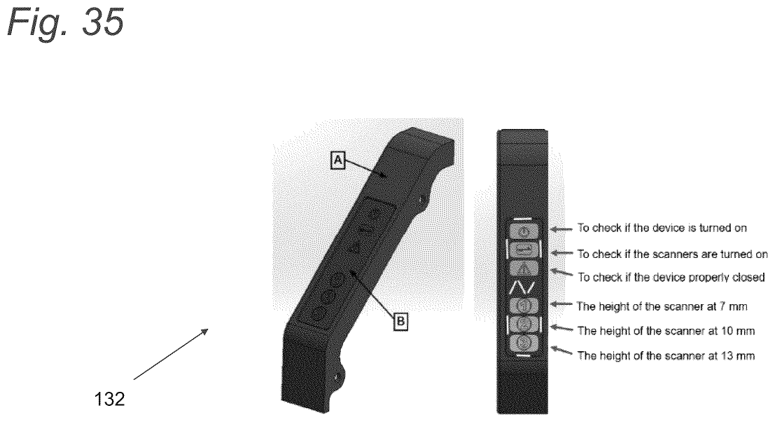

As shown in FIGS. 33-35, there is another embodiment of the apparatus 100, similar to what is disclosed in context of FIGS. 1-32. However, the apparatus 100 includes a panel 132 frontally hosted on one sidewall of the pair of sidewalls 110. This positioning is not required and the panel 132 may be positioned anywhere on the skin of the apparatus 100, or the housing 128, or the housing 106 or another location on one or another sidewall of the pair of sidewalls 110. The panel 132 has a set of visual indicators that visually indicate various statuses. Each of such visual indicators may include a light source, such as a light emitting diode (LED), an incandescent bulb, a gas discharge lamp, a display (e.g., an analog display, a digital display, a liquid crystal display, a plasma display, an electrophoretic display), or another suitable light source, which may be powered as described above, or be omitted. These visual indicators may visually indicate if the apparatus 100 is turned on or off, if the scanning unit 112 is turned on or off, if the scanning unit 130 is turned on or off, if the apparatus 100 is in the closed configuration, a first preset vertical height between the scanning unit 112 and the scanning unit 130, a second preset vertical height between the scanning unit 112 and the scanning unit 130, a third preset vertical height between the scanning unit 112 and the scanning unit 130, or any other suitable status. The panel 132 may have an underside having a stepped structure, as shown in FIG. 34. The panel 132 may be omitted.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function. Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

What is claimed is:

1. A system, comprising:
an apparatus including a base portion and a top portion, wherein the base portion includes a first scanning unit, wherein the top portion includes a second scanning unit; and
a software logic programmed to:
access a first image depicting a bottom surface of an agricultural product and a second image depicting a top surface of the agricultural product based on (i) the agricultural product being positioned between the first scanning unit facing the second scanning unit and the second scanning unit facing the first scanning unit and (ii) the first image being formed by the first scanning unit and the second image being formed by the second scanning unit; and
perform an analysis of the first image and the second image, such that a result of the analysis is displayable.

2. The system of claim 1, wherein the top portion is coupled to the base portion.

3. The system of claim 1, wherein the first scanning unit has a scanning area supporting the agricultural product from thereunder, wherein the base portion includes a housing and a pair of walls, wherein the housing has a top side including the scanning area, wherein the housing houses the first scanning unit, wherein the pair of walls extends from the housing such that the pair of walls and the top side form a U-shape, wherein the pair of walls support the second scanning unit over the top side.

4. The system of claim 1, wherein the base portion includes a gap, a hollow shaft, and compartment, wherein the hollow shaft extends between the gap and the compartment, wherein the gap is adjacent to the first scanning unit, wherein the gap, the hollow shaft, and the compartment are configured such that the gap is able to receive the agricultural product from the first scanning unit and the hollow shaft is able to guide the agricultural product from the gap to the compartment.

5. The system of claim 1, wherein the first scanning unit and the second scanning unit have a vertical distance therebetween, wherein the vertical distance is adjustable based on the first scanning unit or the second scanning unit being movable along a vertical plane.

6. The system of claim 1, wherein the base portion includes a first frame, wherein the top portion includes a second frame, wherein the second frame carries the second scanning unit, wherein the second scanning unit engages the first frame through the second frame, such that the second scanning unit is configured to travel via the first frame along a horizontal plane.

7. The system of claim 1, wherein the base portion includes a first frame, wherein the top portion includes a second frame, wherein the second frame carries the second scanning unit, wherein the first scanning unit engages the first frame, such that the first scanning unit is configured to travel via the first frame along a vertical plane.

8. The system of claim 1, wherein the first scanning unit begins to move or scan the agricultural product before the second scanning unit begins to move or scan the agricultural product.

9. The system of claim 1, wherein the second scanning unit begins to move or scan the agricultural product before the first scanning unit begins to move or scan the agricultural product.

10. The system of claim 1, wherein the first scanning unit and the second scanning unit begin to move or scan the agricultural product simultaneously.

11. The system of claim 1, wherein the first scanning unit hosts a light source or a light sensor, a first stripe, and a second stripe, wherein (i) the light source or the light sensor is positioned between the first stripe and the second stripe or (ii) the light source is configured to output a light between the first stripe and the second stripe.

12. The system of claim 1, wherein the second scanning unit hosts a light source or a light sensor, a first stripe, and a second stripe, wherein (i) the light source or the light sensor is positioned between the first stripe and the second stripe or (ii) the light source is configured to output a light between the first stripe and the second stripe.

13. The system of claim 1, wherein the first scanning unit hosts a first stripe of a first configuration and a second stripe of a second configuration, wherein the second scanning unit hosts a third stripe of the first configuration and a fourth stripe of the second configuration.

14. The system of claim 1, wherein the apparatus includes a panel with a visual indicator to indicate a status of (i) whether the apparatus is turned on or off, (ii) whether the first scanning unit is turned on or off, (iii) whether the second scanning unit is turned on or off, (iv) whether the apparatus is closed, or (v) what preset vertical height between the first scanning unit and the second scanning unit is selected.

15. The system of claim 1, wherein the analysis includes (i) perform a perspective correction on the first image or the second image, (ii) align the first image and the second image with each other, (iii) segment each object in the first image and each object in the second image after the perspective correction is performed and the first image and the second image are aligned with each other, (iv) pair each individually segmented object in the first image with its counterpart individually segmented object in the second image, (v) form a composite image depicting each object in the first image with its matched counterpart object in the second image, (vi) input the composite image into a classification algorithm, such that the classification algorithm outputs a label for the composite image, (vii) input the composite image and the label into a physical weight estimation algorithm, such that the physical weight estimation algorithm outputs a physical weight estimate, (viii) formulate a ratio estimate, a percentage estimate, or a proportion estimate for the agricultural product based on the label and the physical weight estimate, wherein the result includes the ratio estimate, the percentage estimate, or the proportion estimate.

16. An apparatus, comprising:
a base portion and a top portion, wherein the base portion includes a first scanning unit, wherein the top portion includes a second scanning unit, wherein the first scanning is configured to form a first image depicting a bottom surface of an agricultural product and the second scanning unit is configured to form a second image depicting a top surface of the agricultural product based on the agricultural product being positioned between the first scanning unit facing the second scanning unit and the second scanning unit facing the first scanning unit.

17. An apparatus, comprising:
a first portion and a second portion, wherein the first portion includes a first scanning unit, wherein the second portion includes a second scanning unit, wherein the first scanning unit is configured to form a first image depicting a first surface of an agricultural product and the second scanning unit is configured to form a second image depicting a second surface of the agricultural product based on the agricultural product extending between the first scanning unit facing the second scanning unit and the second scanning unit facing the first scanning unit.

18. The apparatus of claim 17, wherein the first portion and the second portion oppose each other along a horizontal plane.

19. The apparatus of claim 17, wherein the first portion and the second portion oppose each other along a vertical plane.

20. The apparatus of claim 17, wherein the first portion and the second portion oppose each other along a diagonal plane.
